(19) United States
(12) Patent Application Publication
(10) Pub. No.: US 2022/0046677 A1
(43) Pub. Date: Feb. 10, 2022

(54) HYBRID AUTOMATIC REPEAT REQUEST (HARQ) ENHANCEMENTS FOR ULTRA-RELIABLE LOW LATENCY COMMUNICATION (URLLC)

(71) Applicant: Intel Corporation, Santa Clara, CA (US)

(72) Inventors: Salvatore Talarico, Sunnyvale, CA (US); Yujian Zhang, Beijing (CN); Debdeep Chatterjee, San Jose, CA (US); Sergey Panteleev, Nizhny Novgorod (RU); Fatemeh Hamidi-Sepehr, Santa Clara, CA (US); Toufiqul Islam, Santa Clara, CA (US)

(21) Appl. No.: 17/508,086

(22) Filed: Oct. 22, 2021

Related U.S. Application Data
(60) Provisional application No. 63/104,168, filed on Oct. 22, 2020.
(60) Provisional application No. 63/105,137, filed on Oct. 23, 2020.

(51) Int. Cl. H04W 72/12; H04L 1/16; H04W 72/14

(52) U.S. Cl. CPC H04W 72/1268; H04W 72/14; H04W 72/1284; H04L 1/1671

(57) ABSTRACT

Various embodiments herein relate to techniques for ultra-reliable and low latency communication (URLLC) in wireless cellular networks. For example, embodiments include hybrid automatic repeat request (HARQ) enhancements for URLLC. Additionally, embodiments include techniques for determining a HARQ identifier (ID) for multi-transport block (TB) transmissions, such as multi-TB configured grant transmissions and/or multi-TB transmissions in unlicensed spectrum.

### CROSS REFERENCE TO RELATED APPLICATION

The present application claims priority to U.S. Provisional Patent Application No. 63/104,168, which was filed Oct. 22, 2020; U.S. Provisional Patent Application No. 63/105,137, which was filed Oct. 23, 2020; the disclosures of which are hereby incorporated by reference.

### FIELD

Various embodiments generally may relate to the field of wireless communications. For example, some embodiments may relate to ultra reliable and low latency communications (URLLC).

### BACKGROUND

The achievable latency and reliability performance of New Radio (NR) are keys to support use cases with tighter requirements. In order to extend the NR applicability in various verticals, 3GPP Release (Rel)-16 NR evolved to support use cases including the following:
Release 15 enabled use case improvements
   Such as augmented reality (AR)/virtual reality (VR) (e.g., entertainment industry)
New Release 16 use cases with higher requirements, such as
   Factory automation
   Transport Industry
   Electrical Power Distribution

In 3GPP Rel. 17, work on further enhancing the NR technology supporting Ultra-Reliable Low Latency Communication (URLLC) and Industrial Internet-of-Things (IIoT) has started.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 illustrates a substitute physical uplink control channel (PUCCH) resource(s) substituting original PUCCH which is dropped due to collision with DL symbols in the same time unit or in another time unit, in accordance with various embodiments.

FIG. 2 illustrates a physical downlink shared channel (PDSCH) grouping for hybrid automatic repeat request (HARD) feedback compression, in accordance with various embodiments.

FIG. 3 illustrates splitting an aggregated PDSCH factor onto multiple PDSCH candidates, in accordance with various embodiments.

FIG. 4 illustrates splitting an aggregated PDSCH factor onto multiple PDSCH candidates by a splitting factor, in accordance with various embodiments.

FIG. 5 illustrates a single PUSCH overlap with more than one (>1) PUCCH repetition, in accordance with various embodiments.

FIG. 6 illustrates a PUCCH resource in a PUCCH cell group, in accordance with various embodiments.

FIG. 7 illustrates a multi-transport block (TB) transmission per period, in accordance with various embodiments.

FIG. 8 schematically illustrates a wireless network in accordance with various embodiments.

FIG. 9 schematically illustrates components of a wireless network in accordance with various embodiments.

FIG. 10 is a block diagram illustrating components, according to some example embodiments, able to read instructions from a machine-readable or computer-readable medium (e.g., a non-transitory machine-readable storage medium) and perform any one or more of the methodologies discussed herein.

FIGS. 11 and 12 illustrate example processes to practice various embodiments herein.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A or B” and “A/B” mean (A), (B), or (A and B).

Various embodiments herein relate to techniques for ultra-reliable and low latency communication (URLLC) in wireless cellular networks. For example, embodiments include hybrid automatic repeat request (HARQ) enhancements for URLLC. Additionally, embodiments include techniques for determining a HARQ identifier (ID) for multi-transport block (TB) transmissions, such as multi-TB configured grant transmissions and/or multi-TB transmissions in unlicensed spectrum.

### HARQ Enhancements for URLLC

As discussed above, in 3GPP Rel. 17, work is ongoing for further enhancing the NR technology supporting URLLC and Industrial Internet-of-Things (IIoT). One of the objectives of this working item is to enhance the HARQ feedback from a UE. In 3GPP Meeting RAN1#102-e, an agreement was made outlining the directions for further enhancements:

Support Rel-17 enhancements to avoid SPS HARQ-ACK dropping for TDD due to PUCCH collision with at least one DL or flexible symbol.
This topic is to be considered as high priority
For future study (FFS) detailed solution(s)

Study further at least the following schemes:
SPS HARQ skipping for ‘skipped’ SPS PDSCH
PUCCH repetition enhancements (at least for HARQ-ACK), e.g., sub-slot based, etc.
Retransmission of cancelled HARQ
SPS HARQ payload size reduction and/or skipping for ‘non-skipped’ SPS PDSCH
Type 1 HARQ codebook based on sub-slot PUCCH config
PUCCH carrier switching for HARQ feedback

Among other things, embodiments of the present disclosure are directed to providing novel technologies, systems, and methods to solve the identified issues above. Aspects of various embodiments herein include:
Alternate/substitute PUCCH resources for avoidance of DL SPS HARQ-ACK dropping;
Grouping of DL SPS PDSCH occasions for HARQ feedback compression;
Enhanced UCI resource elements mapping for repeated PUCCH piggybacked on PUSCH;

Additional PUCCH resource for retransmission of dropped low-priority PUCCH; and/or
Dynamic PUCCH resource determination for carrier aggregation.
   Avoiding frequent dropping of SPS HARQ-ACK in TDD

One of the issues identified for the Rel. 17 working item is reducing the dropping of SPS HARQ-ACK due to collision with symbols designated for DL transmissions which are semi-statically or dynamically configured. In Rel. 15, it was assumed that the UL resources for HARQ-feedback information could be properly provisioned by the gNB considering single SPS configuration per bandwidth part and 10 ms minimum SPS periodicity. However, in Rel. 16, the DL SPS procedures were enhanced with multiple concurrent DL SPS configurations (up to 8) and shorter periodicities (down to 1 slot), that makes provisioning of SPS HARQ-ACK feedback resources quite challenging without relying on potential PUCCH dropping.

Among the available solutions, there are the following options:
Postponing of the feedback(s) to the next valid occasion, which actually does not result in dropping.
Retransmission of the dropped feedback(s).

Each of the aforementioned solutions may have different variations, which are elaborated upon below.

In one embodiment, a UE may be configured as part of DL SPS configuration (RRC information element: SPS-Config), with enabled or disabled postponing of the HARQ feedback. When enabled, a UE may be instructed to modify the corresponding K1 value signalled as part of DL SPS configuration by applying one of the following rules:

In one option, the value of the K1 offset referred by the index PDSCH-to-HARQ feedback field in DCI 1_0/1_1/1_2 can be increased by one Time Unit (TU) or m TUs, where m could be predefined or configurable, until a PUCCH resource indicated as part of the DL SPS configuration can be mapped w/o dropping:
When a UE is not configured with sub-slot based PUCCH configuration, the time unit refers to one slot.
When a UE is configured with sub-slot based PUCCH configuration, the time unit refers to one sub-slot which can be 2, 4, 7 symbols.

In another option, the value of the PDSCH-to-HARQ_feedback field in DCI 1_0/1_1/1_2 indicates an index to the table of the possible K1 values provided by the RRC configured table ‘dl-DataToUL-ACK’ or ‘dl-DataToUL-ACK-r16’ or ‘dl-DataToUL-ACK-DCI-1-2416’ or by the default table in case of DCI 1_0, and the UE is expected to choose the closest larger value of the offset from the same table which fulfils the condition of mapping of the PUCCH.

In another option, a bitmap pattern over possible PUCCH occasions within a configured period may be provided as part of PUCCH configuration or DL SPS configuration, wherein each bit in the pattern may indicate whether a PUCCH occasion is allowed for mapping a postponed and/or original PUCCH. Furthermore, each entry in the pattern may be multi-state/multi-bit, where a single state may refer to one or a combination of:
an occasion is allowed for postponed PUCCH mapping
an occasion is not allowed for postponed PUCCH mapping
an occasion is allowed for dropping PUCCH
an occasion is not allowed for dropping PUCCH
an occasion is allowed for multiplexing of PUCCH
an occasion is not allowed for multiplexing of PUCCH

In one embodiment, a UE may be configured as part of DL SPS configuration (RRC information element: SPS-Config), with ‘substitute’ PUCCH resources for DL SPS HARQ feedback. When provided, a UE may use another configured PUCCH resource in case of dropping of the original PUCCH due to collision with DL symbols:

In one option, one additional PUCCH resource can be provided as part of the DL SPS configuration in a form of PUCCH resource ID, which indicates particular resource from the PUCCH resource set provided as part of PUCCH-Config.

In another option, a set of additional PUCCH resources can be provided as part of DL SPS configuration in a form of a list of PUCCH resource IDs. A UE in this case should attempt to map PUCCH resources one-by-one starting from the first resource in the list and find a resource not causing dropping, if any.

In another option, a pair of {PUCCH resource, time offset} can be provided as a substitute PUCCH resource for DL SPS HARQ-ACK feedback. In this case, when the original PUCCH resource indicated by the PDSCH-to-HARQ_feedback field in DCI 1_0/1_1/1_2 collides with DL symbols, a UE is expected to switch to the substitute PUCCH resource in the time unit (slot or sub-slot) indicated by the time offset in the provided pair of parameters.

In another option, a set of pairs of {PUCCH resource, time offset} can be provided as substitute PUCCH resources for DL SPS HARQ-ACK feedback. A UE in this case should try PUCCH resources one-by-one starting from the first pair of the resource and the time offset in the list and find a resource not causing dropping, if any.

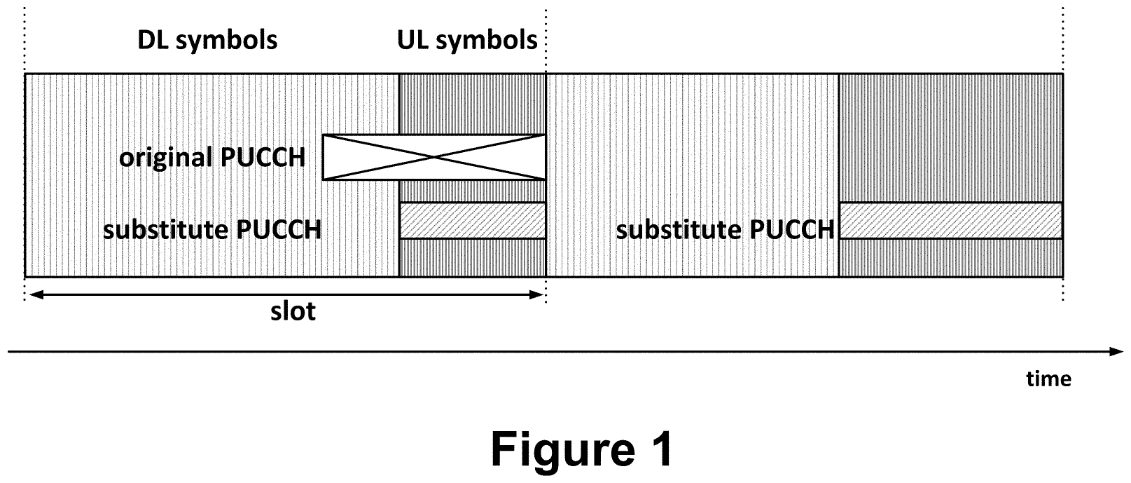

In FIG. 1, the concept of a substitute PUCCH resource or a set of substitute PUCCH resources is illustrated. Here an original PUCCH resource is indicated in the first slot to be of 6 symbols, while a substitute resource of 4 symbols with the same ending symbol is provided in the same slot. In addition, it is illustrated how a substitute resource can be provided in the next slot.

In the context of above embodiments, a new PUCCH (postponed or substitute) may be used by a UE only in case of collision with semi-static DL symbols or semi-static flexible symbols. Additionally the new PUCCH may be mapped after collision of the original PUCCH with dynamic DL symbols or flexible symbols for which DCI format 2_0 is not detected. In the latter case, a gap between the original PUCCH and the new PUCCH is expected to fulfill PUCCH overriding timeline. The gap duration is to reflect UE's (re-)processing time due to preparation of the PUCCH, involving one or more of encoding, modulation, mapping, and consequently UL PC determination again (since the PUCCH format and resource allocation can change). Still, some restrictions may also be defined with respect to the PUCCH format and/or resource allocation, to reduce the PUCCH (re-)preparation additional processing time.

In one embodiment, a UE is not expected to be provide with the backup/substitute PUCCH resource resulting in a starting symbol earlier than the original PUCCH.

Further in the context of the above embodiments, a UE can be provided with a pattern over the DL SPS occasion indicating which of the DL SPS occasions PDSCH can be provided with DL SPS HARQ-ACK without using substitute PUCCH resources. In particular, a bitmap of length L and an offset S counted from the first occasion after the SFN=0 may be configured as part of SPS-Config per DL SPS configuration, where a first state of the bit in the bitmap corresponds to the SPS PDSCH occasion which does not apply substitute PUCCH resource(s) and a second state of the bit in the bitmap corresponds to the SPS PDSCH occasion which can utilize substitute PUCCH resource(s) for corresponding HARQ-ACK feedback. In one embodiment, a UE may be provided with one or multiple UL configured grant configurations that can be used to multiplex the substitute PUCCH, created by dropping of the original PUCCH carrying DL SPS HARQ-ACK. In this case, after the collision of the original PUCCH with DL SPS HARQ-ACK, a UE chooses the closest later CG occasion and multiplexes UCI on PUSCH. When there is no UL-SCH, a UE in one option can transmit PUCCH, in another option it can transmit UCI utilizing same procedure as A-CSI on PUSCH without UL-SCH.

Grouping of PDSCH for HARQ feedback compression

With short periodicities and multiple configurations of DL SPS, a non-negligible fraction of occasions may be unused by gNB for PDSCH transmission. Short SPS periodicities and multiple configurations may generate excessive amount of HARQ-ACK feedback. In some cases, it is expected that performance may be highly limited by PUCCH transmissions.

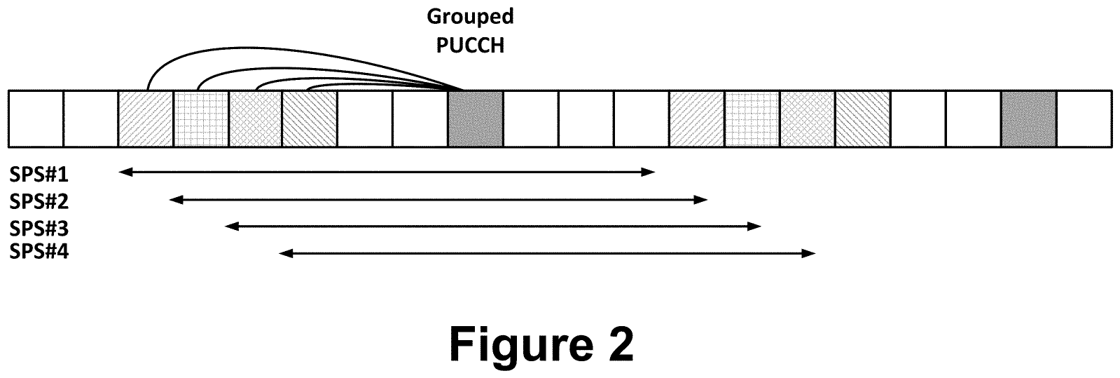

As a special case, there is a potential scheduler implementation to handle quasi-periodic or jitter affected DL packet transfers by allocating a group of PDSCH resources using multiple SPS configurations, wherein in the same period only one of the PDSCHs is utilized by gNB. In this case, at most one of the PDSCH could be successfully decoded by a UE, thus single bit of HARQ feedback information is enough. This is illustrated in FIG. 2.

In one embodiment, a PDSCH occasion is associated with an index Z, wherein the index may be used for HARQ feedback compression. In particular, in a given PUCCH occasion all HARQ feedback bits associated with PDSCH occasions indicated with the same index Z, can be compressed into 1 bit by applying logical OR, e.g. the bit is ‘1’ if at least one of the HARQ feedback bits before compression is ‘1’ (e.g. ACK), or compressed by applying logical AND.

In this option, the index Z may be optionally signaled as part of SPS-Config for each DL SPS configurations. If not provided, then the compression does not affect HARQ feedback for this configuration/occasion and it has a dedicated bit in HARQ CB. Alternatively, a pattern over PDSCH occasions of a DL SPS configuration may be provided in a form of a set of indexes {Z}, where for each of the PDSCH occasions of a DL SPS configuration a different index Z can be provided.

In one embodiment, SPS PDSCH occasions with the same DL SPS HARQ ID with HARQ-ACK information mapped to the same PUCCH resource/UCI may be grouped/compressed into one HARQ-ACK bit in the codebook by logical OR or by logical AND. This is possible when gNB provides harq-ProcID-Offset for DL SPS configurations which result in same HARQ ID for grouped PDSCH (e.g. the same harq-ProcID-Offset).

In another embodiment, grouping of PDSCH occasions can be realized by re-interpreting the PDSCH repetition factor so that each repetition may be decoded by a UE separately without soft combining, assuming the gNB utilizes only one repetition for actual PDSCH transmission and drops other repetitions. In this case, no explicit grouping of HARQ bits is needed since a repeated PDSCH transmission is already associated with one HARQ-ACK bit.

To realize this option, a UE can be provided with the following parameters:

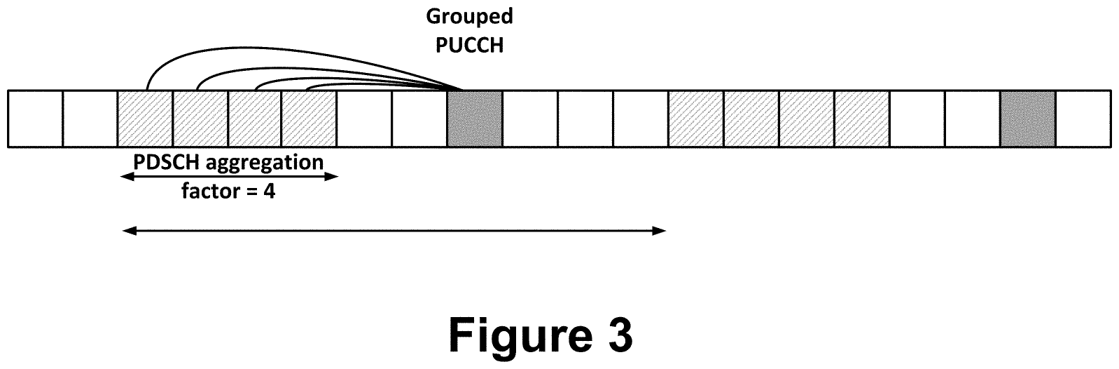

In one option, a UE is provided with a flag as part of semi-static RRC configuration in SPS-Config or as part of DCI activating the SPS configuration, indicating that the PDSCH aggregation factor is re-interpreted as the number of separate occasions to transmit a TB, and no combining between occasions is allowed. This is illustrated in FIG. 3. In this option, a PUCCH resource for the HARQ-ACK information is derived following the same procedure as for the aggregated PDSCH calculating from the last repetition.

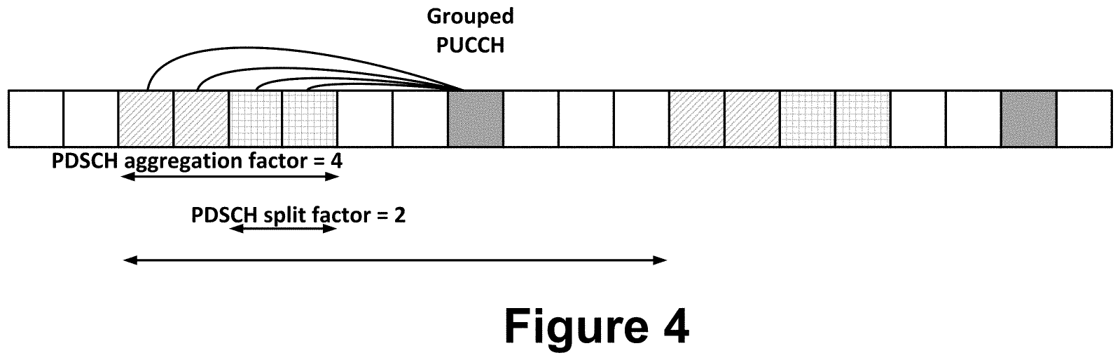

In another option, a UE is provided with an integer number of “splitting factor” with meaningful states from 1 to PDSCH aggregation factor, indicating the number of PDSCH decoding candidates ‘k’ that may be mapped within a number of consecutive slots given by PDSCH-Aggregation Factor ‘R’ configured by higher layers, such that each PDSCH candidate can be received assuming aggregation of floor(R/k). For example, if PDSCH aggregation factor is configured to be 4, and the “splitting factor” is equal to 2, then first two PDSCH occasions are decoded and combined as a first PDSCH candidate and the second two PDSCH occasions are decoded and combined as a second PDSCH candidate. Then the two HARQ-ACK bits generated by the different candidates are bundled/compressed into one HARQ-ACK bit by logical OR (or by logical AND). This is illustrated in FIG. 4. In this option, a PUCCH resource to carry each of the HARQ-ACK bits after bundling may be determined following the rule for the aggregated PDSCH before splitting, e.g. as an offset from the last PDSCH repetition.

### Sub-Slot PUCCH Repetition Handling

In Rel. 16, a mechanism to handle sub-slot PUCCH transmissions was introduced aiming to increase the number of HARQ feedback transmission opportunities for faster feedback as well as better handling of multiplexed service types.

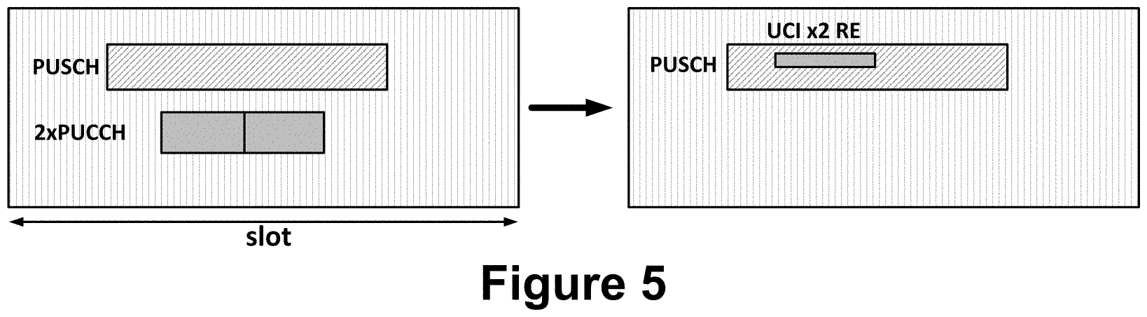

When repetitions of sub-slot PUCCH are enabled how multiplexing of a repeated PUCCH onto PUSCH in a form of UCI piggybacking may need to be optimized, for the case of equal priority. The issue is illustrated in left side of FIG. 5.

In one embodiment, when R PUCCH repetitions are colliding with one PUSCH, then the number of REs for UCI in this case can be scaled up R times subject to other constraints, as illustrated in FIG. 5. For example, for the case when PUSCH is not transmitted with PUSCH repetition type B for the case of HARQ-ACK multiplexing, the formula may look like:

$${{Q}^{′}}_{ACK} = min \{ ⌈ \frac{R \cdot ( {O}_{A C K} + {L}_{A C K} ) \cdot {β}_{offset}^{P U S C H} \cdot {\sum }_{l = 0}^{{N}_{symb , all}^{PUSCH} - 1} {M}_{s c}^{U C I} ( l )}{{\sum }_{r = 0}^{{C}_{UL - SCH} - 1} {K}_{r}} ⌉ , ⌈ α \cdot {\sum }_{l = {l}_{o}}^{{N}_{symb , {all}^{- 1}}^{PUSCH}} {M}_{s c}^{U C I} ( l ) ⌉ \}$$

In the other cases, when PUSCH repetition type B is used and/or for other UCI information similar changes may be made to the UCI REs formula by multiplying the part with β_{offset}^{PUSCH} by the number of overlapping PUCCH.

### Retransmission of Cancelled HARQ

Rel. 15 and 16 procedures in several scenarios lead to dropping of PUCCH transmissions. This may introduce adverse effects to both link and system performance. For example, a lower priority PUCCH may be dropped due to intra-UE prioritization, or due to reception of UL cancellation indication. Additional mechanisms for reducing the impact of PUCCH dropping by PUCCH retransmission may be introduced.

In one embodiment, a UE may be provided with an alternate PUCCH resource for transmission of HARQ-ACK or other UCI based on dynamic trigger. The alternate PUCCH resource is assumed to carry same UCI information as the original PUCCH resource. There are two different approaches for handling the alternate PUCCH resource:

In a first option, the alternate PUCCH resource may be utilized by the UE regardless of the dropping of the original PUCCH resource, acting as a repetition of HARQ-ACK information. In this case, a UE does not expect an original PUCCH resource and an alternate PUCCH resource to overlap in time domain.

In a second option, the alternate PUCCH resource may only be utilized by the UE when the original PUCCH resource is not used due to dropping.

In a third option, when an alternate PUCCH resource is provided, it is also indicated whether the resource is utilized only in case of the original PUCCH resource dropping or in all cases.

Related to the above embodiment, the alternate PUCCH resource may be scheduled by a new field in DCI format 1_1/1_2. A new RRC message can semi-statically enable or disable the presence of the new field in the DCI, including its size. In one option, when the presence is enabled, the alternate PUCCH resource ID field can be of the same size as the original PUCCH resource ID (PRI) field. In another option, the size of the alternate PUCCH resource ID field may be separately provided by RRC configuration or may be pre-defined in the specification as X bit, where X can be 0 or 1 or 2 or 3 or 4 or 5 or 6. In one example, the“alternate” PUCCH resources may be determined using the same PUCCH-Config that is used for the original PUCCH resource. In another example, the “alternate” PUCCH resources may occur in the same slot or sub-slot (latter, when the UE is configured with sub-slot based PUCCH for HARQ-ACK feedback) as the original PUCCH resource. Alternatively, the “alternate” PUCCH resources may occur in a slot or sub-slot that may be different from that of the original PUCCH resource. In such a case, in one option, an additional slot offset may be indicated with respect to the slot or sub-slot corresponding to the original PUCCH resource, with such information being conveyed by a new PRI bitfield or by extending K1-slot (or sub-slot) offset bitfield in the scheduling DCI format.

Related to the above embodiment, a UE is not expected to be indicated with the alternate PUCCH when a time gap between the original PUCCH and the new PUCCH is smaller than a certain re-preparation time denoted as Z, which may be same as the PUCCH overriding timeline. When the alternate PUCCH resource has same parameters as the original PUCCH, the time gap may be reduced comparing to the maximum value, e.g. by an integer number of symbols Y, so that Z′=Z−Y, where Z, Z′, Y may be function of DL, UL sub-carrier spacing.

### PUCCH Carrier Switching for HARQ Feedback

In NR Rel. 15 and 16, in a PUCCH group, a PUCCH with HARQ feedback can only be transmitted on a semi-statically configured carrier. In some combinations of TDD configurations on different carriers, the latency of HARQ feedback reporting can be improved by dynamic selection of PUCCH carrier where UL resources are allocated earlier.

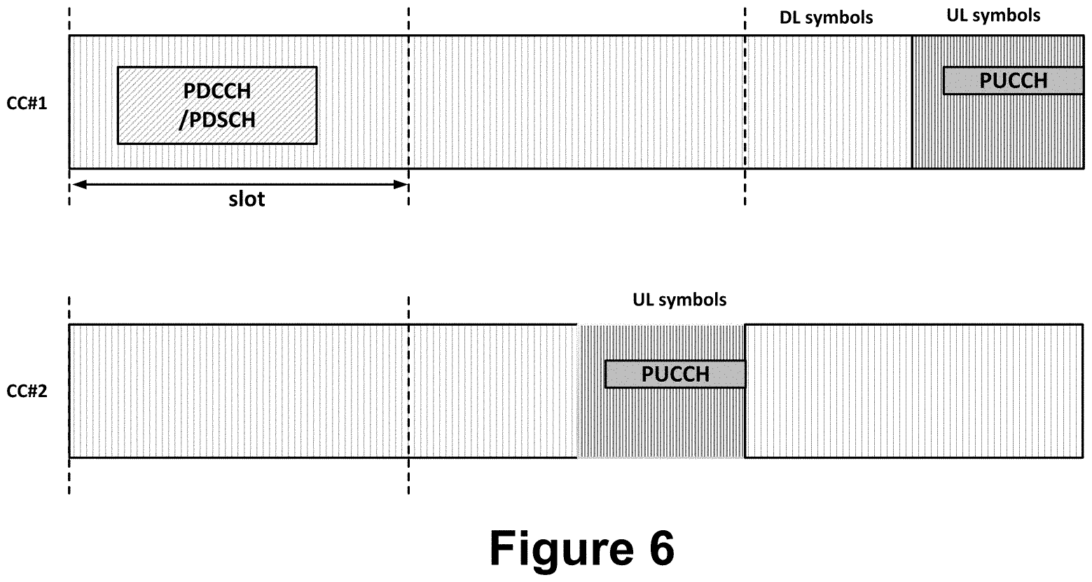

As illustrated in FIG. 6, the carrier for PUCCH resource in a group is currently semi-statically configured (CC#1 in the example in the figure). In some cases, the delay to acknowledge PDSCH can be quite large due to UL-DL configuration. There could be resources closer to the PDSCH in another carrier, but it is not possible to schedule PUCCH in another carrier dynamically.

In one embodiment, a UE may be enabled by an RRC message with dynamic switching of a component carrier where dynamically triggered PUCCH can be transmitted. When enabled, a UE can map PUCCH on the carrier dynamically indicated by the trigger. In the following one of the options can be adopted, which provide how to map a carrier to a PUCCH.

In one option, component carrier index (CID) can be provided as an optional parameter for a given PUCCH resource as part of PUCCH-Config. If present, when the corresponding signalled PUCCH resource ID resource is triggered, the CID is applied to indicate the actual carrier for transmission.

In another option, a component carrier index for PUCCH resource can be separately indicated in DCI format 1_1 or 1_2. In this case, the UE first should look up for the PUCCH resource configuration provided for the carrier separately signalled in DCI, and then apply the PUCCH resource and the PDSCH-to-HARQ_feedback on this carrier. Alternatively, the PUCCH resource indicator could be extended where one part of the bits (e.g. MSB or LSB) can indicate the CID for PUCCH resource, and another part of the bitfield can indicate the PUCCH resource ID.

In yet another option, a single enhanced PUCCH resource ID can be associated with a pair (or a set) of actual PUCCH resources on different component carriers. If PDSCH-to-HARQ_feedback field in DCI applied on the semi-statically associated PUCCH carrier results in overlap with DL symbols, a UE is expected to use the PUCCH resource on another carrier and apply the same PDSCH-to-HARQ_feedback interpreted in the numerology of the another carrier.

### HARQ ID Determination for Multi-TB Configured Grant Transmissions for URLLC Operating in Unlicensed Spectrum

In many of the communication scenarios described herein, one of the major limiting factors is still the availability in spectrum. To mitigate this, one of the objectives of 3GPP Rel.17 is to identify potential enhancements to ensure Rel. 16 feature compatibility with unlicensed band URLLC/IIoT operation in controlled environment.

While this Work Item (WI) is at its initial stage, it is important to identify aspects of the design that can be enhanced when operating in unlicensed spectrum. One of the challenges is that the system must comply with the regulatory requirements dictated for the sub-6 GHz band, where a listen before talk (LBT) procedure needs to be performed in some parts of the world to acquire the medium before a transmission can occur as described in ETSI EN 301 893, while still being able to guarantee the requirements in terms of reliability and latency identified for the design of URLLC/IIoT to meet the aforementioned use cases. Additional design considerations must be therefore made in this regard. In fact, when operating URLLC/IIoT in the unlicensed spectrum, due to the LBT procedure and its aleatory nature, additional latency and loss in reliability may be introduced depending on the medium contention when the LBT fails.

In Rel.16 NR-U, a dynamic grant UE suffers from multiple levels of contention: 1) UE has to send scheduling request (SR), 2) an LBT has to be performed at the gNB before sending UL grant (especially in the case of self-carrier scheduling), 3) UE has to be scheduled (internal contention amongst UEs associated with the same gNB) and 4) LBT has to be performed by the scheduled UE before transmission. Furthermore, the four subframes necessary for processing delay between UL grant and PUSCH transmission represent an additional performance constraint. In order to cope with these multiple levels of contention that a dynamic grant UE suffers from, a “UE-centric” design has been also established for configured-grant (CG) operation. For CG transmissions, given a set of time domain resources, a UE has the capability to decide when to transmit without any constrains or level of control from a gNB, and in order to cope with possible LBT failures it can attempt to perform LBT in multiple occasions. In order to achieve the latter, it is left up to the UE on choosing the HARQ-ID to use from a given set of values, instead of assigning to a UE a specific HARQ-ID, which is linked to the specific time domain resource from which the UL transmission starts, which in case of LBT failure would limit a give UE to reattempt transmission only in specific instance of time assigned for that HARQ-ID which would result in many cases in unacceptable system level degradation in terms of latency and delay. While for CG UEs, the HARQ-ID chosen is up to the UE itself, this information is provided by the UE to the gNB through the use of a CG-UCI, which is piggybacked in every CG-PUSCH transmission.

For both the Rel. 15 and Rel.16 URLLC UEs, the HARQ-ID is instead determined as described in Sec. 5.4.1 in TS 38.321 as follows:
If the parameter harq-ProcID-Offset2 is not configured, then:

HARQ Process ID=[floor(CURRENT_symbol/periodicity)] modulo nrofHARQ-Processes
If the parameter harq-ProcID-Offset2 is configured, then:

HARQ Process ID=[floor(CURRENT_symbol/periodicity)] modulo nrofHARQ-Processes+harq-ProcID-Offset2

where
CURRENT_symbol=(SFN×numberOfSlotsPerFrame×numberOfSymbolsPerSlot+slot+number in the frame×numberOfSymbolsPerSlot+symbol number in the slot), and numberOfSlotsPerFrame and numberOfSymbolsPerSlot refer to the number of consecutive slots per frame and the number of consecutive symbols per slot, respectively as specified in TS 38.211;
Periodicity refers to the CG periodicity defined in TS 38.331;
nrofHARQ-Processes refers to the number of HARQ-ACK IDs.

Note that the above formulas have been introduced under the assumption that CG transmissions only support a single transport block (TB) transmission per period.

Moving forward to Rel.17, a harmonization across the way how HARQ-ID is determined for URLLC and the methodology used in Rel.16 for NR-U is required for operating efficiently URLLC in the unlicensed spectrum. In this matter, it is important to note two specific aspects:

1) For Rel. 17 URLLC operating in unlicensed spectrum when the retransmission timer cg-RetransmissionTimer is not configured, the CG-UCI may not be transmitted, meaning that the NR-U procedure for determing the HARQ-ID may not be used, since there would not be any means for the UE to indicate the HARQ-ID chosen to the gNB, and resolve the ambiguity between the UE and the gNB in this matter;

2) For Rel. 17 URLLC operating in unlicensed spectrum, the repetition scheme introduced in both URLLC and NR-U may be harmonized, and the multi-TB transmission within a period introduced in NR-U for the purpose of mitigating the impact of the LBT and for fully utilizing the maximum channel occupancy time (MCOT) may be ported and re-used. With that said, the legacy URLLC procedure for determing the HARQ-ID may not be used, given that, as mentioned above, this has been built under the assumption that a CG transmission would only carry a single TB per period.

Various embodiments herein provide techniques to properly determine the HARQ-ID. The embodiments may close the gap between the URLLC and NR-U design and ensure an effective operation of URLLC in the shared spectrum.

To enable URLLC/IIoT design within the sub-6 GHz band some modifications might be required to the HARQ-ID determination procedure that has been used in Rel.15 and Re116 for URLLC and that has introduced in Rel.16 for NR-U. In this matter, this disclosure provides many details on the possible enhancements and way forward to harmonize the Rel.16 URLLC design with that of Rel.16 NR-U.

### Determination of HARQ-ID

As mentioned above, for Rel.17 URLLC operating in unlicensed spectrum, when the retransmission timer cg-RetransmissionTimer is not configured or in general when the CG-UCI is not used and piggypacked in the CG-PUSCH, both the legacy NR-U and URLLC mechanism to determine the HARQ-ID value to use or allowed to be used in specific time domain resources may not be proper for the following reasons:

In NR-U, the HARQ-ID is solely determined by UE implementation, and selected among HARQ process IDs available for the configured grant configuration. If the CG-UCI is not be transmitted, the gNB would be unaware of HARQ-ID corresponding to that transmission/retransmission, and would not know how to treat it in terms of HARQ-ACK feedback procedure.

In legacy URLLC, the HARQ-ID determination is based under the assumption that a single TB is allowed per period. However, as part of the harmonization between URLLC and NR-U, it is expected that multi-TB transmissions within a period would be introduced so that to have a better utilization of the maximum channel occupancy time (MCOT), and minimize possible LBT overhead, which is highly detrimental for low latency and high reliability applications.

With that said, embodiments for the determination of the HARQ-ID are provided as described further below.

In one embodiment, when the system operates in unlicensed spectrum, the retransmission timer cg-RetransmissionTimer is not configured, and the CG-UCI is not used, then the URLLC legacy formulas used to determine the HARQ-ID are modified to account for multiple TB transmissions within a period.

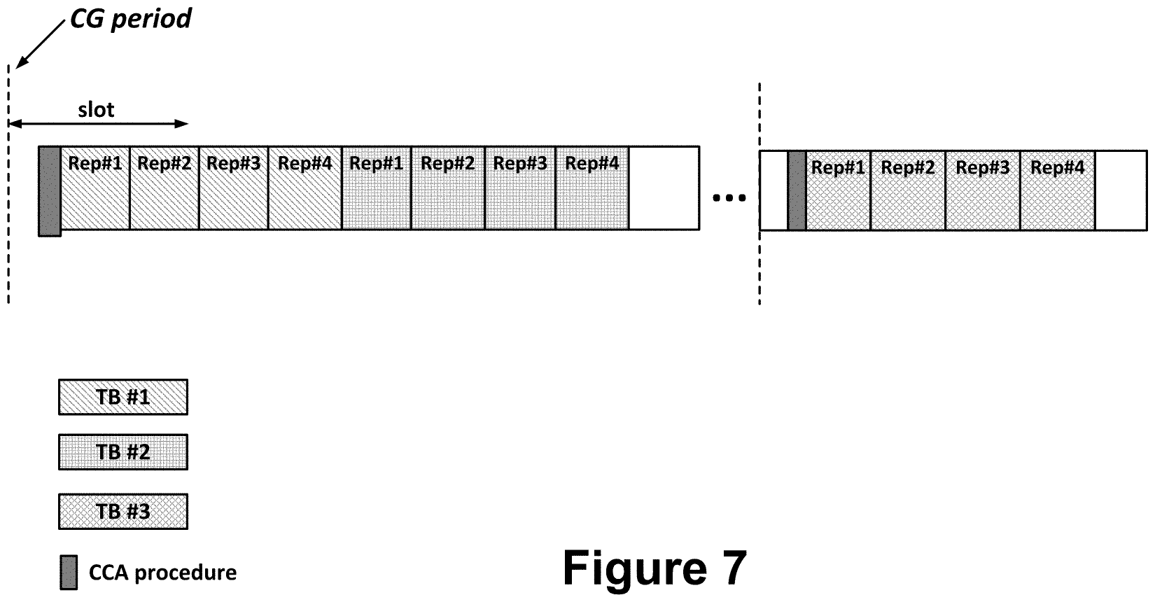

FIG. 7 illustrates an example case when multi-TBs are transmitted within a period, and specifically a maximum of two TBs are transmitted per period each repeated four times. In one example the formulas used to determine the HARQ-ID are modified such that within a period depending on the maximum number of TB allowed, a different HARQ-ID may be provided given a different TB index. For example, the HARQ Process ID calculation could be modified as follows:
When harq-ProcID-Offset2 is not configured then:

HARQ Process ID=[floor(CURRENT_symbol/periodicity)×noofTBsPerPeriod+tb_index] modulo nrofHARQ-Processes
When harq-ProcID-Offset2 is configured then:

HARQ Process ID=[floor(CURRENT_symbol/periodicity)×noofTBsPerPeriod+tb_index] modulo nrofHARQ-Processes

where noofTBsPerPeriod is the maximum number of transport blocks per period, and tb_index=0, . . . , noofTBsPerPeriod-1 is the current TB index within the period.

In one example, the above formulas may be included in Section 5.4.1 in TS38.321, V16.2.0, by updating the current specification text as highlighted below in underline:

For configured uplink grants neither configured with harq-ProcID-Offset2 nor with cg-RetransmissionTimer and when not operating in shared spectrum, the HARQ Process ID associated with the first symbol of a UL transmission is derived from the following equation:

HARQ Process ID=[floor(CURRENT_symbol/periodicity)] modulo nrofHARQ-Processes

For configured uplink grants with harq-ProcID-Offset2 and without cg-RetransmissionTimer, when not operating in shared spectrum, the HARQ Process ID associated with the first symbol of a UL transmission is derived from the following equation:

HARQ Process ID=[floor(CURRENT_symbol/periodicity)] modulo nrofHARQ-Processes+harq-ProcID-Offset2

where CURRENT_symbol=(SFN×numberOfSlotsPerFrame×numberOfSymbolsPerSlot+slot number in the frame×numberOfSymbolsPerSlot+symbol number in the slot), and numberOfSlotsPerFrame and numberOfSymbolsPerSlot refer to the number of consecutive slots per frame and the number of consecutive symbols per slot, respectively as specified in TS 38.211 [8].

For configured uplink grants configured with cg-RetransmissionTimer and when operating in shared spectrum, the UE implementation select an HARQ Process ID among the HARQ process IDs available for the configured grant configuration. The UE shall prioritize retransmissions before initial transmissions. The UE shall toggle the NDI in the CG-UCI for new transmissions and not toggle the NDI in the CG-UCI in retransmissions.

For configured uplink grants neither configured with harq-ProcID-Offset2 nor with cg-RetransmissionTimer and when operating in shared spetrum, the HARQ Process ID associated with the first symbol of a UL transmission is derived from the following equation:

HARQ Process ID=[floor(CURRENT_symbol/periodicity)×noofTBsPerPeriod+tb_index] modulo nrofHARQ-Processes

For configured uplink grants with harq-ProcID-Offset2 and without cg-RetransmissionTimer, when operating in shared spectrum, the HARQ Process ID associated with the first symbol of a UL transmission is derived from the following equation:

HARQ Process ID=[floor(CURRENT_symbol/periodicity)—noofTBsPerPeriod+tb_index] modulo nrofHARQ-Processes+harq-ProcID-Offset2

where noofTBsPerPeriod is the maximum number of transport blocks per period, and tb index=0, . . . , noofTBsPerPeriod-1 is the current TB index within the period.

As part of this example, the HARQ Process ID calculation may be modified as follows:
When harq-ProcID-Offset2 is not configured then:

HARQ Process ID=[floor(CURRENT_symbol_per_TB/periodicity)] modulo nrofHARQ-Processes
When harq-ProcID-Offset2 is configured then:

HARQ Process ID=[floor(CURRENT_symbol_per_TB/periodicity)] modulo nrofHARQ-Processes+harq-ProcID-Offset2

where CURRENT_symbol_per_TB=(SFN×numberOfSlotsPerFrame×numberOfSymbolsPerSlot+slot number in the frame×numberOfSymbolsPerSlot+symbol number in the slot)×noofTBsPerPeriod+tb_index×periodicity indicates the first symbol of a TB for an UL transmission, where noofTBsPerPeriod is the maximum number of transport blocks per period, and tb_index=0, . . . , noofTBsPerPeriod-1 is the current TB index within the period.

In one example, the above formulas can be included in Section 5.4.1 in TS38.321, V16.2.0, by updating the current specification text as highlighted below in underline:

For configured uplink grants neither configured with harq-ProcID-Offset2 nor with cg-RetransmissionTimer and when not operating in shared spectrum, the HARQ Process ID associated with the first symbol of a UL transmission is derived from the following equation:

HARQ Process ID=[floor(CURRENT_symbol/periodicity)] modulo nrofHARQ-Processes

For configured uplink grants with harq-ProcID-Offset2 and without cg-RetransmissionTimer, when not operating in shared spectrum, the HARQ Process ID associated with the first symbol of a UL transmission is derived from the following equation:

HARQ Process ID=[floor(CURRENT_symbol/periodicity)] modulo nrofHARQ-Processes+harq-ProcID-Offset2

where CURRENT_symbol=(SFN×numberOfSlotsPerFrame×numberOfSymbolsPerSlot+slot number in the frame×numberOfSymbolsPerSlot+symbol number in the slot), and numberOfSlotsPerFrame and numberOfSymbolsPerSlot refer to the number of consecutive slots per frame and the number of consecutive symbols per slot, respectively as specified in TS 38.211 [8].

For configured uplink grants configured with cg-RetransmissionTimer and when operating in shared spectrum, the UE implementation select a HARQ Process ID among the HARQ process IDs available for the configured grant configuration. The UE shall prioritize retransmissions before initial transmissions. The UE shall toggle the NDI in the CG-UCI for new transmissions and not toggle the NDI in the CG-UCI in retransmissions.

For configured uplink grants neither configured with harq-ProcID-Offset2 nor with cg-RetransmissionTimer and when operating in shared spetrum, the HARQ Process ID associated with the first symbol of a UL transmission is derived from the following equation:

HARQ Process ID=[floor(CURRENT_symbol_per_TB/periodicity)] modulo nrofHARQ-Processes

For configured uplink grants with harq-ProcID-Offset2 and without cg-RetransmissionTimer, when operating in shared spectrum, the HARQ Process ID associated with the first symbol of a UL transmission is derived from the following equation:

HARQ Process ID=[floor(CURRENT_symbol_per_TB/Periodicity)] modulo nrofHARQ-Processes+harq-ProcID-Offset2

where CURRENT_symbol_per_TB=(SFN×numberOfSlotsPerFrame×numberOfSymbolsPerSlot+slot number in the frame×numberOfSymbolsPerSlot+symbol number in the slot)×noofTBsPerPeriod+tb_index×periodicity, where noofTBsPerPeriod is the maximum number of transport blocks per period, and tb_index=0, . . . , noofTBsPerPeriod-1 is the current TB index within the period.

As another option of this example, the additional formulas introduced are used not depending on whether the cg-RetransmissionTimer is not configured, but based on whether the CG-UCI is not used. For instance, even if the cg-Retransmission Timer may not be configured, the UE may be configured by the network on whether or not to use the CG-UCI through an additional RRC parameter named as an example cg-UCI-enablement. In this case, the new formulas introduced above are used when cg-UCI-enablement is not configured or indicates that the cg-UCI would not be used.

In another example the formulas used to determine the HARQ-ID are modified such that within a period depending on the maximum number of TB allowed, a different HARQ-ID may be provided, assuming that within a period and next one the time domain resources are equally distributed among TBs.

As part of this example, the HARQ Process ID calculation may be modified as follows:
When harq-ProcID-Offset2 is not configured then:

HARQ Process ID=[floor(CURRENT_symbol/periodicity×noofTBsPerPeriod)] modulo nrofHARQ-Processes
When harq-ProcID-Offset2 is configured then:

HARQ Process ID=[floor(CURRENT_symbol/periodicity×noofTBsPerPeriod)] modulo nrofHARQ-Processes+harq-ProcID-Offset2

where noofTBsPerPeriod is the maximum number of transport blocks per period and CURRENT_symbol is the first symbol of a TB transmission or its repetitions, which is calculated as in legacy.

In one example, the above formulas may be included in Section 5.4.1 in TS38.321, V16.2.0, by updating the current specification text as highlighted below in underline:

For configured uplink grants neither configured with harq-ProcID-Offset2 nor with cg-RetransmissionTimer and when not operating in shared spectrum, the HARQ Process ID associated with the first symbol of a UL transmission is derived from the following equation:

HARQ Process ID=[floor(CURRENT_symbol/periodicity)] modulo nrofHARQ-Processes

For configured uplink grants with harq-ProcID-Offset2 and without cg-RetransmissionTimer, when not operating in shared spectrum, the HARQ Process ID associated with the first symbol of a UL transmission is derived from the following equation:

HARQ Process ID=[floor(CURRENT_symbol/periodicity)] modulo nrofHARQ-Processes+harq-ProcID-Offset2

where CURRENT_symbol=(SFN×numberOfSlotsPerFrame×numberOfSymbolsPerSlot+slot number in the frame×numberOfSymbolsPerSlot+symbol number in the slot), and numberOfSlotsPerFrame and numberOfSymbolsPerSlot refer to the number of consecutive slots per frame and the number of consecutive symbols per slot, respectively as specified in TS 38.211 [8].

For configured uplink grants configured with cg-RetransmissionTimer and when operating in shared spectrum, the UE implementation select a HARQ Process ID among the HARQ process IDs available for the configured grant configuration. The UE shall prioritize retransmissions before initial transmissions. The UE shall toggle the NDI in the CG-UCI for new transmissions and not toggle the NDI in the CG-UCI in retransmissions.

For configured uplink grants neither configured with harq-ProcID-Offset2 nor with cg-RetransmissionTimer and when operating in shared spectrum, the HARQ Process ID associated with the first symbol of a TB transmission or its repetitions is derived from the following equation:

HARQ Process ID=[floor(CURRENT_symbol/periodicity×noofTBsPerPeriod)] modulo nrofHARQ-Processes

For configured uplink grants with harq-ProcID-Offset2 and without cg-RetransmissionTimer, when operating in shared spectrum, the HARQ Process ID associated with the first symbol of a TB transmission or its repetitions is derived from the following equation:

HARQ Process ID=[floor(CURRENT_symbol/periodicity×noofTBsPerPeriod)] modulo nrofHARQ-Processes+harq-ProcID-Offset2

where noofTBsPerPeriod is the maximum number of transport blocks per period.

As another option of this example, the additional formulas introduced are used not depending on whether the cg-RetransmissionTimer is not configured, but based on whether the CG-UCI is not used. For instance, even if the cg-Retransmission Timer may not be configured, the UE may be configured by the network on whether or not to use the CG-UCI through an additional RRC parameter named as an example cg-UCI-enablement. In this case, the new formulas introduced above are used when cg-UCI-enablement is not configured or indicates that the cg-UCI would not be used.

In another example, the formulas used to determine the HARQ-ID are modified such that within a period depending on the resources allocated per TB (e.g., this is equivalent to PUSCH_Length×REPETITION_NUMBER, where PUSCH_Length is derived from the SLIV, and may corresponds to the length in terms of symbols of a TB transmission when a TB based transmission is configured, and REPETITION_NUMBER is as defined in 38.321 and is the total number of PUSCH transmissions of a TB), a different HARQ-ID may be provided.

As part of this example, the HARQ Process ID calculation may be modified as follows:
When harq-ProcID-Offset2 is not configured then:

HARQ Process ID=[floor((CURRENT_symbol+floor((CURRENT_symbol+1)/periodicity)*Y)/(TB_resources))] modulo nrofHARQ-Processes
When harq-ProcID-Offset2 is configured then:

HARQ Process ID=[floor((CURRENT_symbol30 floor((CURRENT_symbol+1)/periodicity)*Y)/(TB_resources))] modulo nrofHARQ-Processes+harq-ProcID-Offset2

where TB_resources are the total time domain resources allocated for a TB, Y=(periodicity*2) modulo TB_resources, and CURRENT_symbol is the first symbol of a TB transmission or its repetitions, which is calculated as in legacy.

[000127] In one example, the above formulas may be included in Section 5.4.1 in TS38.321, V16.2.0, by updating the current specification text as highlighted below in underline:

For configured uplink grants neither configured with harq-ProcID-Offset2 nor with cg-RetransmissionTimer and when not operating in shared spectrum, the HARQ Process ID associated with the first symbol of a UL transmission is derived from the following equation:

HARQ Process ID=[floor(CURRENT_symbol/periodicity)] modulo nrofHARQ-Processes

For configured uplink grants with harq-ProcID-Offset2 and without cg-RetransmissionTimer, when not operating in shared spectrum, the HARQ Process ID associated with the first symbol of a UL transmission is derived from the following equation:

HARQ Process ID=[floor(CURRENT_symbol/periodicity)] modulo nrofHARQ-Processes+harq-ProcID-Offset2

where CURRENT_symbol=(SFN×numberOfSlotsPerFrame×numberOfSymbolsPerSlot+slot number in the frame×numberOfSymbolsPerSlot+symbol number in the slot), and numberOfSlotsPerFrame and numberOfSymbolsPerSlot refer to the number of consecutive slots per frame and the number of consecutive symbols per slot, respectively as specified in TS 38.211 [8].

For configured uplink grants configured with cg-RetransmissionTimer and when operating in shared spectrum, the UE implementation select a HARQ Process ID among the HARQ process IDs available for the configured grant configuration. The UE shall prioritize retransmissions before initial transmissions. The UE shall toggle the NDI in the CG-UCI for new transmissions and not toggle the NDI in the CG-UCI in retransmissions.

For configured uplink grants neither configured with harq-ProcID-Offset2 nor with cg-RetransmissionTimer and when operating in shared spectrum, the HARQ Process ID associated with the first symbol of a TB transmission or its repetitions is derived from the following equation:

HARQ Process ID=[floor((CURRENT_symbol+floor((CURRENT_symbol+1)/periodicity)*Y)/(TB_resources))] modulo nrofHARQ-Processes

For configured uplink grants with harq-ProcID-Offset2 and without cg-RetransmissionTimer, when operating in shared spectrum, the HARQ Process ID associated with the first symbol of a TB transmission or its repetitions is derived from the following equation:

HARQ Process ID=[floor((CURRENT_symbol+floor((CURRENT_symbol+1)/periodicity)*Y)/(TB_resources))] modulo nrofHARQ-Processes+harq-ProcID-Offset2

where TB_resources are the total time domain resources allocated for a TB, and Y=(periodicity*2) modulo TB_resources.

As another option of this example, the additional formulas introduced are used not depending on whether the cg-RetransmissionTimer is not configured, but based on whether the CG-UCI is not used. For instance, even if the cg-RetransmissionTimer may not be configured, the UE may be configured by the network on whether or not to use the CG-UCI through an additional RRC parameter named as an example cg-UCI-enablement. In this case, the new formulas introduced above are used when cg-UCI-enablement is not configured or indicates that the cg-UCI would not be used.

In another example, the formulas used to determine the HARQ-ID are modified such that within a period depending on the maximum number of TB allowed, and the resources allocated per TB (e.g., this is equivalent to PUSCH_Length×REPETITION_NUMBER, where PUSCH_Length is derived from the SLIV, and may corresponds to the length in terms of symbols of a TB transmission when a TB based transmission is configured, and REPETITION_NUMBER is as defined in 38.321 and is the total number of PUSCH transmissions of a TB), a different HARQ-ID may be provided.

As part of this example, the HARQ Process ID calculation could be modified as follows:
When harq-ProcID-Offset2 is not configured then:

HARQ Process ID=[floor(CURRENT_symbol/periodicity)×noofTBsPerPeriod+[floor((CURRENT_symbol+floor((CURRENT_symbol+1)/periodicity)×Y)/TB_resources)]modulo noofTBsPerPeriod] modulo nrofHARQ-Processes
When harq-ProcID-Offset2 is configured then:

HARQ Process ID=[floor(CURRENT_symbol/periodicity)×noofTBsPerPeriod+[floor((CURRENT_symbol+floor((CURRENT_symbol+1)/periodicity)×Y)/TB_resources)]modulo noofTBsPerPeriod] modulo nrofHARQ-Processes+harq-ProcID-Offset2

where noofTBsPerPeriod is the maximum number of transport blocks per period, TB_resources are the total time domain resources allocated for a TB, Y=(periodicity*2) modulo TB_resources, and CURRENT_symbol is the first symbol of a TB transmission or its repetitions, which is calculated as in legacy.

In one example, the above formulas may be included in Section 5.4.1 in TS38.321, V16.2.0, by updating the current specification text as highlighted below in underline:

For configured uplink grants neither configured with harq-ProcID-Offset2 nor with cg-RetransmissionTimer and when not operating in shared spectrum, the HARQ Process ID associated with the first symbol of a UL transmission is derived from the following equation:

HARQ Process ID=[floor(CURRENT_symbol/periodicity)]modulo nrofHARQ-Processes

For configured uplink grants with harq-ProcID-Offset2 and without cg-RetransmissionTimer, when not operating in shared spectrum, the HARQ Process ID associated with the first symbol of a UL transmission is derived from the following equation:

HARQ Process ID=[floor(CURRENT_symbol/periodicity)]modulo nrofHARQ-Processes+harq-ProcID-Offset2

where CURRENT_symbol=(SFN×numberOfSlotsPerFrame×numberOfSymbolsPerSlot+slot number in the frame×numberOfSymbolsPerSlot+symbol number in the slot), and numberOfSlotsPerFrame and numberOfSymbolsPerSlot refer to the number of consecutive slots per frame and the number of consecutive symbols per slot, respectively as specified in TS 38.211 [8].

For configured uplink grants configured with cg-RetransmissionTimer and when operating in shared spectrum, the UE implementation select a HARQ Process ID among the HARQ process IDs available for the configured grant configuration. The UE shall prioritize retransmissions before initial transmissions. The UE shall toggle the NDI in the CG-UCI for new transmissions and not toggle the NDI in the CG-UCI in retransmissions.

For configured uplink grants neither configured with harq-ProcID-Offset2 nor with cg-RetransmissionTimer and when operating in shared spetrum, the HARQ Process ID associated with the first symbol of a TB transmission or its repetitions is derived from the following equation:

HARQ Process ID=[floor(CURRENT_symbol/periodicity)×noofTBsPerPeriod+[floor((CURRENT_symbol+1)/periodicity)×Y)/TB_resources)] modulo noofTBsPerPeriod] modulo nrofHARQ-Processes

For configured uplink grants with harq-ProcID-Offset2 and without cg-RetransmissionTimer, when operating in shared spectrum, the HARQ Process ID associated with the first symbol of a TB transmission or its repetitions is derived from the following equation:

HARQ Process ID=[floor(CURRENT_symbol/periodicity)×noofTBsPerPeriod+[floor((CURRENT_symbol+floor((CURRENT_symbol+1)/periodicity)×Y)/TB_resources)] modulo noofTBsPerPeriod] modulo nrofHARQ-Processes+harq-ProcID-Offset2

where noofTBsPerPeriod is the maximum number of transport blocks per period, TB_resources are the total time domain resources allocated for a TB, and Y=(periodicity*2) modulo TB_resources.

As another option of this example, the additional formulas introduced are used not depending on whether the cg-RetransmissionTimer is not configured, but based on whether the CG-UCI is not used. For instance, even if the cg-Retransmission Timer may not be configured, the UE may be configured by the network on whether or not to use the CG-UCI through an additional RRC parameter named as an example cg-UCI-enablement. In this case, the new formulas introduced above are used when cg-UCI-enablement is not configured or indicates that the cg-UCI would not be used.

### Systems and Implementations

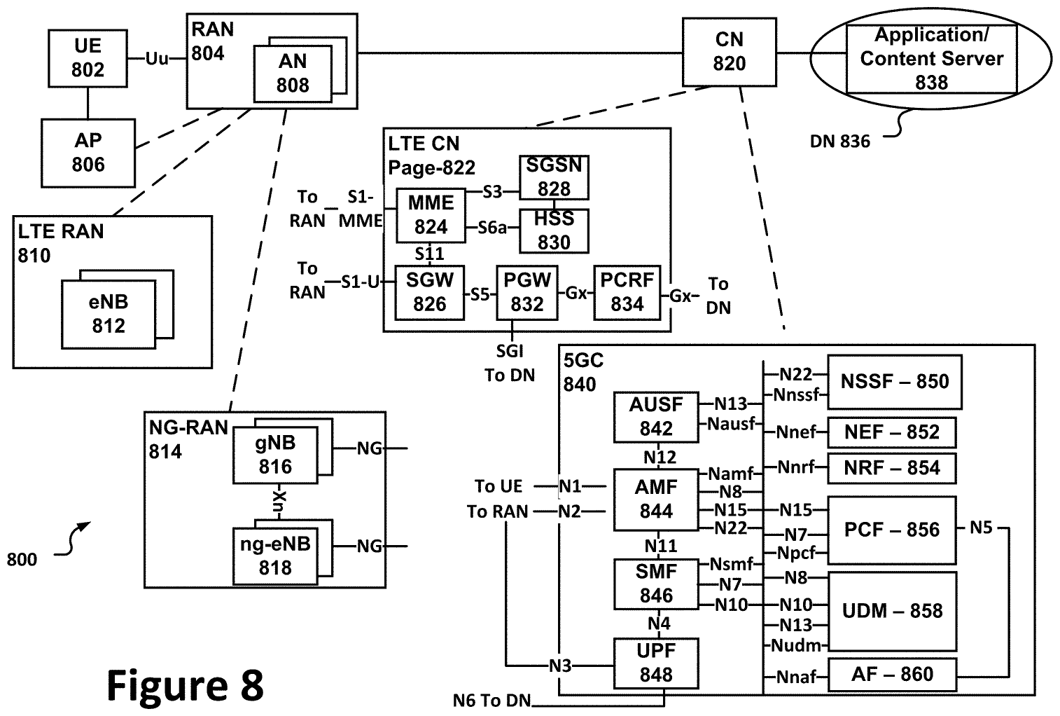

FIGS. 8-10 illustrate various systems, devices, and components that may implement aspects of disclosed embodiments.

FIG. 8 illustrates a network 800 in accordance with various embodiments. The network 800 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 800 may include a UE 802, which may include any mobile or non-mobile computing device designed to communicate with a RAN 804 via an over-the-air connection. The UE 802 may be communicatively coupled with the RAN 804 by a Uu interface. The UE 802 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 800 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 802 may additionally communicate with an AP 806 via an over-the-air connection. The AP 806 may manage a WLAN connection, which may serve to offload some/all network traffic from the RAN 804. The connection between the UE 802 and the AP 806 may be consistent with any IEEE 802.11 protocol, wherein the AP 806 could be a wireless fidelity (Wi-Fi®) router. In some embodiments, the UE 802, RAN 804, and AP 806 may utilize cellular-WLAN aggregation (for example, LWA/LWIP). Cellular-WLAN aggregation may involve the UE 802 being configured by the RAN 804 to utilize both cellular radio resources and WLAN resources.

The RAN 804 may include one or more access nodes, for example, AN 808. AN 808 may terminate air-interface protocols for the UE 802 by providing access stratum protocols including RRC, PDCP, RLC, MAC, and L1 protocols. In this manner, the AN 808 may enable data/voice connectivity between CN 820 and the UE 802. In some embodiments, the AN 808 may be implemented in a discrete device or as one or more software entities running on server computers as part of, for example, a virtual network, which may be referred to as a CRAN or virtual baseband unit pool. The AN 808 be referred to as a BS, gNB, RAN node, eNB, ng-eNB, NodeB, RSU, TRxP, TRP, etc. The AN 808 may be a macrocell base station or a low power base station for providing femtocells, picocells or other like cells having smaller coverage areas, smaller user capacity, or higher bandwidth compared to macrocells.

In embodiments in which the RAN 804 includes a plurality of ANs, they may be coupled with one another via an X2 interface (if the RAN 804 is an LTE RAN) or an Xn interface (if the RAN 804 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 804 may each manage one or more cells, cell groups, component carriers, etc. to provide the UE 802 with an air interface for network access. The UE 802 may be simultaneously connected with a plurality of cells provided by the same or different ANs of the RAN 804. For example, the UE 802 and RAN 804 may use carrier aggregation to allow the UE 802 to connect with a plurality of component carriers, each corresponding to a Pcell or Scell. In dual connectivity scenarios, a first AN may be a master node that provides an MCG and a second AN may be secondary node that provides an SCG. The first/second ANs may be any combination of eNB, gNB, ng-eNB, etc.

[000164] The RAN 804 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 802 or AN 808 may be or act as a RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 804 may be an LTE RAN 810 with eNBs, for example, eNB 812. The LTE RAN 810 may provide an LTE air interface with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operating on sub-6 GHz bands.

In some embodiments, the RAN 804 may be an NG-RAN 814 with gNBs, for example, gNB 816, or ng-eNBs, for example, ng-eNB 818. The gNB 816 may connect with 5G-enabled UEs using a 5G NR interface. The gNB 816 may connect with a 5G core through an NG interface, which may include an N2 interface or an N3 interface. The ng-eNB 818 may also connect with the 5G core through an NG interface, but may connect with a UE via an LTE air interface. The gNB 816 and the ng-eNB 818 may connect with each other over an Xn interface.

In some embodiments, the NG interface may be split into two parts, an NG user plane (NG-U) interface, which carries traffic data between the nodes of the NG-RAN 814 and a UPF 848 (e.g., N3 interface), and an NG control plane (NG-C) interface, which is a signaling interface between the nodes of the NG-RAN 814 and an AMF 844 (e.g., N2 interface).

The NG-RAN 814 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 802 can be configured with multiple BWPs where each BWP configuration has a different SCS. When a BWP change is indicated to the UE 802, the SCS of the transmission is changed as well. Another use case example of BWP is related to power saving. In particular, multiple BWPs can be configured for the UE 802 with different amount of frequency resources (for example, PRBs) to support data transmission under different traffic loading scenarios. A BWP containing a smaller number of PRBs can be used for data transmission with small traffic load while allowing power saving at the UE 802 and in some cases at the gNB 816. A BWP containing a larger number of PRBs can be used for scenarios with higher traffic load.

The RAN 804 is communicatively coupled to CN 820 that includes network elements to provide various functions to support data and telecommunications services to customers/subscribers (for example, users of UE 802). The components of the CN 820 may be implemented in one physical node or separate physical nodes. In some embodiments, NFV may be utilized to virtualize any or all of the functions provided by the network elements of the CN 820 onto physical compute/storage resources in servers, switches, etc. A logical instantiation of the CN 820 may be referred to as a network slice, and a logical instantiation of a portion of the CN 820 may be referred to as a network sub-slice.

In some embodiments, the CN 820 may be an LTE CN 822, which may also be referred to as an EPC. The LTE CN 822 may include MME 824, SGW 826, SGSN 828, HSS 830, PGW 832, and PCRF 834 coupled with one another over interfaces (or “reference points”) as shown. Functions of the elements of the LTE CN 822 may be briefly introduced as follows.

The MME 824 may implement mobility management functions to track a current location of the UE 802 to facilitate paging, bearer activation/deactivation, handovers, gateway selection, authentication, etc.

The SGW 826 may terminate an Si interface toward the RAN and route data packets between the RAN and the LTE CN 822. The SGW 826 may be a local mobility anchor point for inter-RAN node handovers and also may provide an anchor for inter-3GPP mobility. Other responsibilities may include lawful intercept, charging, and some policy enforcement.

The SGSN 828 may track a location of the UE 802 and perform security functions and access control. In addition, the SGSN 828 may perform inter-EPC node signaling for mobility between different RAT networks; PDN and S-GW selection as specified by MME 824; MME selection for handovers; etc. The S3 reference point between the MME 824 and the SGSN 828 may enable user and bearer information exchange for inter-3GPP access network mobility in idle/active states.

The HSS 830 may include a database for network users, including subscription-related information to support the network entities' handling of communication sessions. The HSS 830 can provide support for routing/roaming, authentication, authorization, naming/addressing resolution, location dependencies, etc. An S6a reference point between the HSS 830 and the MME 824 may enable transfer of subscription and authentication data for authenticating/authorizing user access to the LTE CN 820.

The PGW 832 may terminate an SGi interface toward a data network (DN) 836 that may include an application/content server 838. The PGW 832 may route data packets between the LTE CN 822 and the data network 836. The PGW 832 may be coupled with the SGW 826 by an S5 reference point to facilitate user plane tunneling and tunnel management. The PGW 832 may further include a node for policy enforcement and charging data collection (for example, PCEF). Additionally, the SGi reference point between the PGW 832 and the data network 8 36 may be an operator external public, a private PDN, or an intra-operator packet data network, for example, for provision of IMS services. The PGW 832 may be coupled with a PCRF 834 via a Gx reference point.

The PCRF 834 is the policy and charging control element of the LTE CN 822. The PCRF 834 may be communicatively coupled to the app/content server 838 to determine appropriate QoS and charging parameters for service flows. The PCRF 832 may provision associated rules into a PCEF (via Gx reference point) with appropriate TFT and QCI.

In some embodiments, the CN 820 may be a 5GC 840. The 5GC 840 may include an AUSF 842, AMF 844, SMF 846, UPF 848, NSSF 850, NEF 852, NRF 854, PCF 856, UDM 858, and AF 860 coupled with one another over interfaces (or “reference points”) as shown. Functions of the elements of the 5GC 840 may be briefly introduced as follows.

The AUSF 842 may store data for authentication of UE 802 and handle authentication-related functionality. The AUSF 842 may facilitate a common authentication framework for various access types. In addition to communicating with other elements of the 5GC 840 over reference points as shown, the AUSF 842 may exhibit an Nausf service-based interface.

The AMF 844 may allow other functions of the 5GC 840 to communicate with the UE 802 and the RAN 804 and to subscribe to notifications about mobility events with respect to the UE 802. The AMF 844 may be responsible for registration management (for example, for registering UE 802), connection management, reachability management, mobility management, lawful interception of AMF-related events, and access authentication and authorization. The AMF 844 may provide transport for SM messages between the UE 802 and the SMF 846, and act as a transparent proxy for routing SM messages. AMF 844 may also provide transport for SMS messages between UE 802 and an SMSF. AMF 844 may interact with the AUSF 842 and the UE 802 to perform various security anchor and context management functions. Furthermore, AMF 844 may be a termination point of a RAN CP interface, which may include or be an N2 reference point between the RAN 804 and the AMF 844; and the AMF 844 may be a termination point of NAS (N1) signaling, and perform NAS ciphering and integrity protection. AMF 844 may also support NAS signaling with the UE 802 over an N3 IWF interface.

The SMF 846 may be responsible for SM (for example, session establishment, tunnel management between UPF 848 and AN 808); UE IP address allocation and management (including optional authorization); selection and control of UP function; configuring traffic steering at UPF 848 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 844 over N2 to AN 808; and determining SSC mode of a session. SM may refer to management of a PDU session, and a PDU session or “session” may refer to a PDU connectivity service that provides or enables the exchange of PDUs between the UE 802 and the data network 836.

The UPF 848 may act as an anchor point for intra-RAT and inter-RAT mobility, an external PDU session point of interconnect to data network 836, and a branching point to support multi-homed PDU session. The UPF 848 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 848 may include an uplink classifier to support routing traffic flows to a data network.

The NSSF 850 may select a set of network slice instances serving the UE 802. The NSSF 850 may also determine allowed NSSAI and the mapping to the subscribed S-NSSAIs, if needed. The NSSF 850 may also determine the AMF set to be used to serve the UE 802, or a list of candidate AMFs based on a suitable configuration and possibly by querying the NRF 854. The selection of a set of network slice instances for the UE 802 may be triggered by the AMF 844 with which the UE 802 is registered by interacting with the NSSF 850, which may lead to a change of AMF. The NSSF 850 may interact with the AMF 844 via an N22 reference point; and may communicate with another NSSF in a visited network via an N31 reference point (not shown). Additionally, the NSSF 850 may exhibit an Nnssf service-based interface.

The NEF 852 may securely expose services and capabilities provided by 3GPP network functions for third party, internal exposure/re-exposure, AFs (e.g., AF 860), edge computing or fog computing systems, etc. In such embodiments, the NEF 852 may authenticate, authorize, or throttle the AFs. NEF 852 may also translate information exchanged with the AF 860 and information exchanged with internal network functions. For example, the NEF 852 may translate between an AF-Service-Identifier and an internal 5GC information. NEF 852 may also receive information from other NFs based on exposed capabilities of other NFs. This information may be stored at the NEF 852 as structured data, or at a data storage NF using standardized interfaces. The stored information can then be re-exposed by the NEF 852 to other NFs and AFs, or used for other purposes such as analytics. Additionally, the NEF 852 may exhibit an Nnef service-based interface.

The NRF 854 may support service discovery functions, receive NF discovery requests from NF instances, and provide the information of the discovered NF instances to the NF instances. NRF 854 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 854 may exhibit the Nnrf service-based interface.

The PCF 856 may provide policy rules to control plane functions to enforce them, and may also support unified policy framework to govern network behavior. The PCF 856 may also implement a front end to access subscription information relevant for policy decisions in a UDR of the UDM 858. In addition to communicating with functions over reference points as shown, the PCF 856 exhibit an Npcf service-based interface.

The UDM 858 may handle subscription-related information to support the network entities' handling of communication sessions, and may store subscription data of UE 802. For example, subscription data may be communicated via an N8 reference point between the UDM 858 and the AMF 844. The UDM 858 may include two parts, an application front end and a UDR. The UDR may store subscription data and policy data for the UDM 858 and the PCF 856, and/or structured data for exposure and application data (including PFDs for application detection, application request information for multiple UEs 802) for the NEF 852. The Nudr service-based interface may be exhibited by the UDR 221 to allow the UDM 858, PCF 856, and NEF 852 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 858 may exhibit the Nudm service-based interface.

The AF 860 may provide application influence on traffic routing, provide access to NEF, and interact with the policy framework for policy control.

In some embodiments, the 5GC 840 may enable edge computing by selecting operator/3rd party services to be geographically close to a point that the UE 802 is attached to the network. This may reduce latency and load on the network. To provide edge-computing implementations, the 5GC 840 may select a UPF 848 close to the UE 802 and execute traffic steering from the UPF 848 to data network 836 via the N6 interface. This may be based on the UE subscription data, UE location, and information provided by the AF 860. In this way, the AF 860 may influence UPF (re)selection and traffic routing. Based on operator deployment, when AF 860 is considered to be a trusted entity, the network operator may permit AF 860 to interact directly with relevant NFs. Additionally, the AF 860 may exhibit an Naf service-based interface.

The data network 836 may represent various network operator services, Internet access, or third party services that may be provided by one or more servers including, for example, application/content server 838.

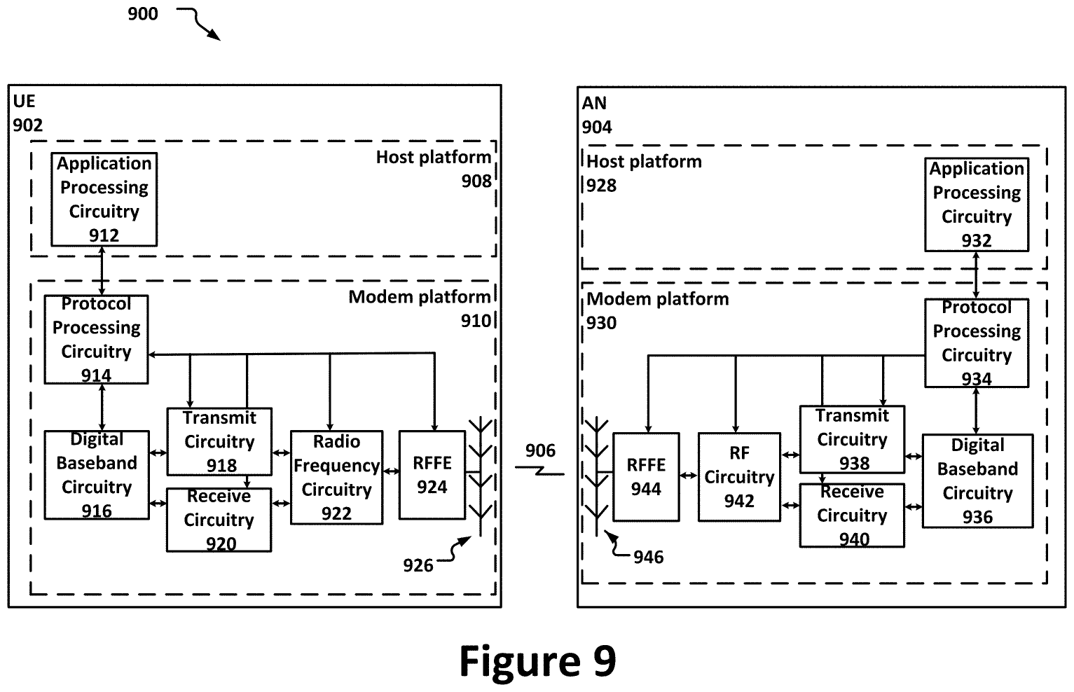

FIG. 9 schematically illustrates a wireless network 900 in accordance with various embodiments. The wireless network 900 may include a UE 902 in wireless communication with an AN 904. The UE 902 and AN 904 may be similar to, and substantially interchangeable with, like-named components described elsewhere herein.

The UE 902 may be communicatively coupled with the AN 904 via connection 906. The connection 906 is illustrated as an air interface to enable communicative coupling, and can be consistent with cellular communications protocols such as an LTE protocol or a 5G NR protocol operating at mmWave or sub-6GHz frequencies.

The UE 902 may include a host platform 908 coupled with a modem platform 910. The host platform 908 may include application processing circuitry 912, which may be coupled with protocol processing circuitry 914 of the modem platform 910. The application processing circuitry 912 may run various applications for the UE 902 that source/sink application data. The application processing circuitry 912 may further implement one or more layer operations to transmit/receive application data to/from a data network. These layer operations may include transport (for example UDP) and Internet (for example, IP) operations.

The protocol processing circuitry 914 may implement one or more of layer operations to facilitate transmission or reception of data over the connection 906. The layer operations implemented by the protocol processing circuitry 914 may include, for example, MAC, RLC, PDCP, RRC and NAS operations.

The modem platform 910 may further include digital baseband circuitry 916 that may implement one or more layer operations that are “below” layer operations performed by the protocol processing circuitry 914 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 910 may further include transmit circuitry 918, receive circuitry 920, RF circuitry 922, and RF front end (RFFE) 924, which may include or connect to one or more antenna panels 926. Briefly, the transmit circuitry 918 may include a digital-to-analog converter, mixer, intermediate frequency (IF) components, etc.; the receive circuitry 920 may include an analog-to-digital converter, mixer, IF components, etc.; the RF circuitry 922 may include a low-noise amplifier, a power amplifier, power tracking components, etc.; RFFE 924 may include filters (for example, surface/bulk acoustic wave filters), switches, antenna tuners, beamforming components (for example, phase-array antenna components), etc. The selection and arrangement of the components of the transmit circuitry 918, receive circuitry 920, RF circuitry 922, RFFE 924, and antenna panels 926 (referred generically as “transmit/receive components”) may be specific to details of a specific implementation such as, for example, whether communication is TDM or FDM, in mmWave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 914 may include one or more instances of control circuitry (not shown) to provide control functions for the transmit/receive components.

A UE reception may be established by and via the antenna panels 926, RFFE 924, RF circuitry 922, receive circuitry 920, digital baseband circuitry 916, and protocol processing circuitry 914. In some embodiments, the antenna panels 926 may receive a transmission from the AN 904 by receive-beamforming signals received by a plurality of antennas/antenna elements of the one or more antenna panels 926.

A UE transmission may be established by and via the protocol processing circuitry 914, digital baseband circuitry 916, transmit circuitry 918, RF circuitry 922, RFFE 924, and antenna panels 926. In some embodiments, the transmit components of the UE 904 may apply a spatial filter to the data to be transmitted to form a transmit beam emitted by the antenna elements of the antenna panels 926.

Similar to the UE 902, the AN 904 may include a host platform 928 coupled with a modem platform 930. The host platform 928 may include application processing circuitry 932 coupled with protocol processing circuitry 934 of the modem platform 930. The modem platform may further include digital baseband circuitry 936, transmit circuitry 938, receive circuitry 940, RF circuitry 942, RFFE circuitry 944, and antenna panels 946. The components of the AN 904 may be similar to and substantially interchangeable with like-named components of the UE 902. In addition to performing data transmission/reception as described above, the components of the AN 908 may perform various logical functions that include, for example, RNC functions such as radio bearer management, uplink and downlink dynamic radio resource management, and data packet scheduling.

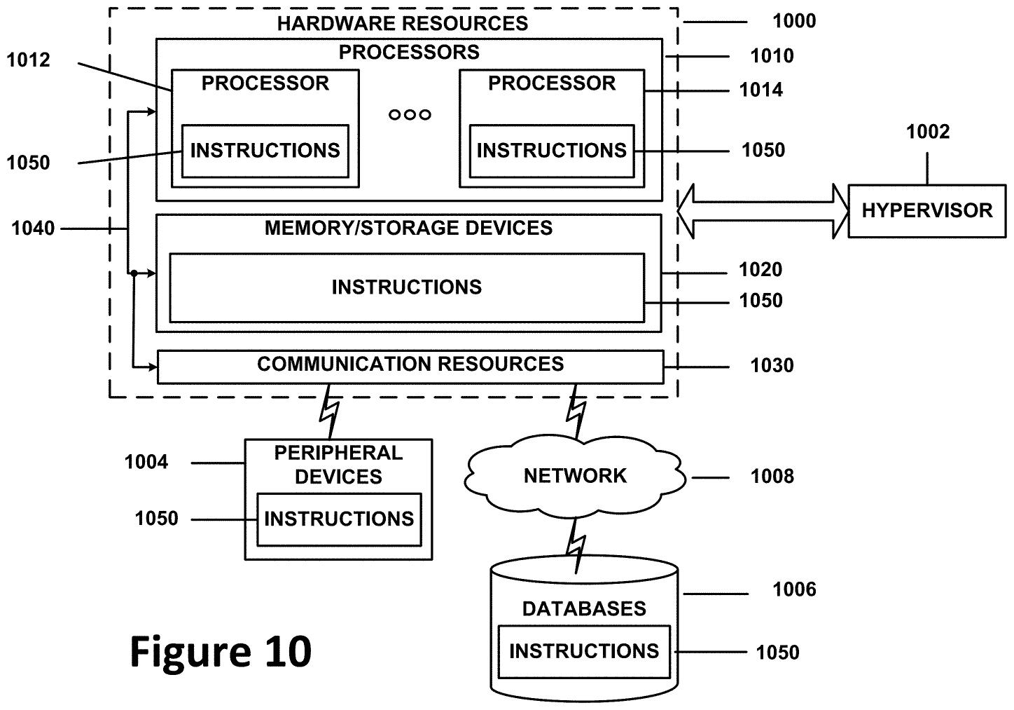

FIG. 10 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 10 shows a diagrammatic representation of hardware resources 1000 including one or more processors (or processor cores) 1010, one or more memory/storage devices 1020, and one or more communication resources 1030, each of which may be communicatively coupled via a bus 1040 or other interface circuitry. For embodiments where node virtualization (e.g., NFV) is utilized, a hypervisor 1002 may be executed to provide an execution environment for one or more network slices/sub-slices to utilize the hardware resources 1000.

The processors 1010 may include, for example, a processor 1012 and a processor 1014. The processors 1010 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 1020 may include main memory, disk storage, or any suitable combination thereof. The memory/storage devices 1020 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 1030 may include interconnection or network interface controllers, components, or other suitable devices to communicate with one or more peripheral devices 1004 or one or more databases 1006 or other network elements via a network 1008. For example, the communication resources 1030 may include wired communication components (e.g., for coupling via USB, Ethernet, etc.), cellular communication components, NFC components, Bluetooth® (or Bluetooth® Low Energy) components, Wi-Fi® components, and other communication components.

Instructions 1050 may comprise software, a program, an application, an applet, an app, or other executable code for causing at least any of the processors 1010 to perform any one or more of the methodologies discussed herein. The instructions 1050 may reside, completely or partially, within at least one of the processors 1010 (e.g., within the processor's cache memory), the memory/storage devices 1020, or any suitable combination thereof. Furthermore, any portion of the instructions 1050 may be transferred to the hardware resources 1000 from any combination of the peripheral devices 1004 or the databases 1006. Accordingly, the memory of processors 1010, the memory/storage devices 1020, the peripheral devices 1004, and the databases 1006 are examples of computer-readable and machine-readable media.

### Example Procedures

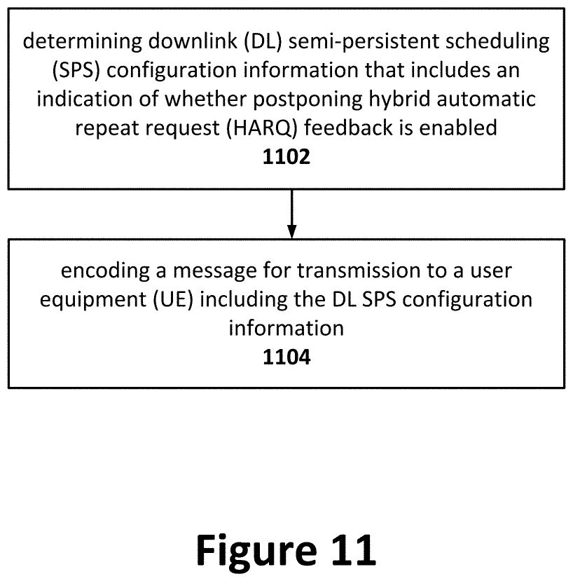

In some embodiments, the electronic device(s), network(s), system(s), chip(s) or component(s), or portions or implementations thereof, of FIGS. 8-10, or some other figure herein, may be configured to perform one or more processes, techniques, or methods as described herein, or portions thereof. One such process is depicted in FIG. 11, which may be performed by a gNB in some embodiments. For example, the process may include, at 1102, determining downlink (DL) semi-persistent scheduling (SPS) configuration information that includes an indication of whether postponing hybrid automatic repeat request (HARQ) feedback is enabled or disabled. The process further includes, at 1104, encoding a message for transmission to a user equipment (UE) including the DL SPS configuration information.

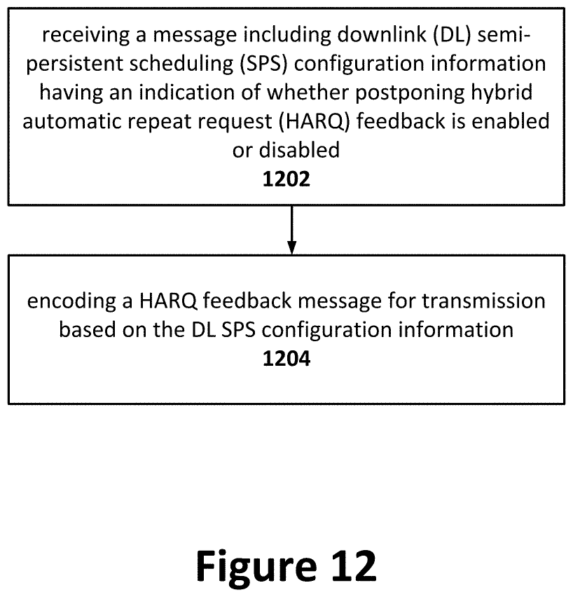

Another such process is illustrated in FIG. 12, which may be performed by a UE in some embodiments. In this example, the process includes, at 1202, receiving a message including downlink (DL) semi-persistent scheduling (SPS) configuration information having an indication of whether postponing hybrid automatic repeat request (HARQ) feedback is enabled or disabled. The process further includes, at 1204, encoding a HARQ feedback message for transmission based on the DL SPS configuration information.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

Example 1 may include a method of operating a wireless network to provide enhanced Hybrid ARQ (HARQ) procedures for NR downlink reception acknowledgement, the method comprising: configuring, by a gNB, additional PUCCH resources for mapping of dropped HARQ-ACK feedback; configuring, by a gNB, grouping of SPS PDSCH occasions for HARQ-ACK bits compression; and configuring, by a gNB, of dynamic PUCCH carrier switching.

Example 2 may include the method of example 1 or some other example herein, wherein a UE may be configured as part of DL SPS configuration (RRC information element: SPS-Config), with enabled or disabled postponing of the HARQ feedback. When enabled, a UE may be instructed to modify the corresponding K1 value signalled as part of DL SPS configuration.

Example 3 may include the method of example 2 or some other example herein, wherein the value of the K1 offset referred by the index PDSCH-to-HARQ_feedback field in DCI 1_0/1_1/1_2 can be increased by one Time Unit (TU) or m TUs, where m could be predefined or configurable, until a PUCCH resource indicated as part of the DL SPS configuration can be mapped w/o dropping.

Example 4 may include the method of example 2 or some other example herein, wherein the value of the PDSCH-to-HARQ feedback field in DCI 1_0/1_1/1_2 indicates an index to the table of the possible K1 values provided by the RRC configured table ‘dl-DataToUL-ACK’ or ‘dl-DataToUL-ACK-r16’ or ‘dl-DataToUL-ACK-DCI-1-2-r16’ or by the default table in case of DCI 1_0, and the UE is expected to choose the closest larger value of the offset from the same table which fulfils the condition of mapping of the PUCCH.

Example 5 may include the method of example 1 or some other example herein, wherein a UE may be configured as part of DL SPS configuration (RRC information element: SPS-Config), with ‘substitute’ PUCCH resources for DL SPS HARQ feedback. When provided, a UE may use another configured PUCCH resource in case of dropping of the original PUCCH due to collision with DL symbols.

Example 6 may include the method of example 1 or some other example herein, wherein a UE can be provided with a pattern over the DL SPS occasion indicating which of the DL SPS occasions PDSCH can be provided with DL SPS HARQ-ACK without using substitute PUCCH resources.

Example 7 may include the method of example 1 or some other example herein, wherein a PDSCH occasion is associated with an index Z, wherein the index may be used for HARQ feedback compression. In particular, in a given PUCCH occasion all HARQ feedback bits associated with PDSCH occasions indicated with the same index Z, can be compressed into 1 bit by applying logical OR, e.g. the bit is ‘1’ if at least one of the HARQ feedback bits before compression is ‘1’ (e.g. ACK), or compressed by applying logical AND.

Example 8 may include the method of example 1 or some other example herein, wherein SPS PDSCH occasions with the same DL SPS HARQ ID with HARQ-ACK information mapped to the same PUCCH resource/UCI may be grouped/compressed into one HARQ-ACK bit in the codebook by logical OR or by logical AND.

Example 9 may include the method of example 1 or some other example herein, wherein grouping of PDSCH occasions can be realized by re-interpreting the PDSCH repetition factor so that each repetition may be decoded by a UE separately without soft combining, assuming the gNB utilizes only one repetition for actual PDSCH transmission and drops other repetitions.

Example 10 may include the method of example 1 or some other example herein, wherein when R PUCCH repetitions are colliding with one PUSCH, then the number of REs for UCI in this case can be scaled up R times subject to other constraints.

Example 11 may include the method of example 1 or some other example herein, wherein a UE may be provided with an alternate PUCCH resource for transmission of HARQ-ACK or other UCI based on dynamic trigger. The alternate PUCCH resource is assumed to carry same UCI information as the original PUCCH resource. The alternate PUCCH may be utilized when the original PUCCH is subject to dropping.

Example 12 may include the method of example 1 or some other example herein, wherein, a UE may be enabled by an RRC message with dynamic switching of a component carrier where dynamically triggered PUCCH can be transmitted. When enabled, a UE can map PUCCH on the carrier dynamically indicated by the trigger. In the following one of the options can be adopted, which provide how to map a carrier to a PUCCH.

Example 13 may include the method of example 12 or some other example herein, wherein a single enhanced PUCCH resource ID can be associated with a pair (or a set) of actual PUCCH resources on different component carriers. If PDSCH-to-HARQ_feedback field in DCI applied on the semi-statically associated PUCCH carrier results in overlap with DL symbols, a UE is expected to use the PUCCH resource on another carrier and apply the same PDSCH-to-HARQ_feedback interpreted in the numerology of the another carrier.

Example 14 includes a method comprising: determining downlink (DL) semi-persistent scheduling (SPS) configuration information that includes an indication of whether postponing hybrid automatic repeat request (HARQ) feedback is enabled or disabled; and encoding a message for transmission to a user equipment (UE), the message including the DL SPS configuration information.

Example 15 includes the method of example 14 or some other example herein, wherein the message is encoded for transmission to the UE via radio resource control (RRC) signaling, and the DL SPS configuration information is included in an RRC information element (IE).

Example 16 includes the method of example 15 or some other example herein, wherein the RRC IE is SPS-Config.

Example 17 includes the method of example 14 or some other example herein, wherein the DL SPS configuration information includes an indication of a substitute physical uplink control channel (PUCCH) resource for the HARQ feedback.

Example 18 includes the method of example 17 or some other example herein, wherein the DL SPS configuration information includes an indication of an additional PUCCH resource identifier of a PUCCH resource from a PUCCH resource set.

Example 19 includes the method of example 17 or some other example herein, wherein the DL SPS configuration information includes an indication of a plurality of PUCCH resource identifiers corresponding to a respective plurality of PUCCH resources.

Example 20 includes the method of example 17 or some other example herein, wherein the indication of the substitute PUCCH resource includes an indication of a time offset for the substitute PUCCH resource.

Example 21 includes the method of example 14 or some other example herein, wherein the DL SPS configuration information includes an indication of a DL SPS occasion for which a physical downlink shared channel (PDSCH) can be provided with a DL SPS HARQ acknowledgement (ACK) without using a substitute PUCCH resource.

Example 22 includes the method of example 14 or some other example herein, wherein the DL SPS configuration information includes an indication of one or more uplink (UL) configured grant configurations with which to multiple a substitute PUCCH.

Example 23 includes the method of example 14 or some other example herein, wherein the DL SPS configuration information includes an indication of a PDSCH occasion associated with an index for HARQ feedback compression.

Example 24 includes the method of example 14 or some other example herein, wherein the DL SPS configuration information includes an indication of an alternate PUCCH resource for transmission of HARQ-ACK or uplink control information (UCI) based on a dynamic trigger.

Example 25 includes the method of example 24 or some other example herein, wherein the DL SPS configuration information includes an indication of enablement or disablement of a downlink control information (DCI) field that schedules the alternate PUCCH resource.

Example 26 includes the method of example 14 or some other example herein, wherein the DL SPS configuration information includes an indication of dynamic switching of a component carrier where dynamically triggered PUCCH may be transmitted.

Example 27 includes the method of any of examples 14-26 or some other example herein, wherein the method is performed by a next-generation NodeB (gNB) or portion thereof.

Example 28 includes a method of a user equipment (UE) comprising: receiving a message including downlink (DL) semi-persistent scheduling (SPS) configuration information having an indication of whether postponing hybrid automatic repeat request (HARQ) feedback is enabled or disabled; and encoding, by the UE, a HARQ feedback message for transmission based on the DL SPS configuration information.

Example 28a includes the method of example 28 or some other example herein, further comprising modifying an offset value (K1).

Example 28b includes the method of example 28a or some other example herein, wherein the K1 offset value is referred to in a PDSCH-to-HARQ feedback field in DCI 1_0/1_1/1_2.

Example 28c includes the method of example 28a or some other example herein, wherein modifying the K1 offset value includes increasing the K1 offset value by one time unit (TU) or multiple (m) Tus such that a PUCCH resource can be mapped without dropping.

Example 28d includes the method of example 28c or some other example herein, wherein the TU is one slot.

Example 28e includes the method of example 28c or some other example herein, wherein the TU is one sub-slot of 2, 4, or 7 symbols.

Example 29 includes the method of example 28 or some other example herein, wherein the message is received by the UE via radio resource control (RRC) signaling, and the DL SPS configuration information is included in an RRC information element (IE).

Example 30 includes the method of example 29 or some other example herein, wherein the RRC IE is SPS-Config.

Example 31 includes the method of example 28 or some other example herein, wherein the DL SPS configuration information includes an indication of a substitute physical uplink control channel (PUCCH) resource for the HARQ feedback.

Example 31a includes the method of example 31 or some other example herein, wherein the UE utilizes the substitute PUCCH only in response to a collision with semi-static DL symbols or semi-static flexible symbols.

Example 32 includes the method of example 31 or some other example herein, wherein the DL SPS configuration information includes an indication of an additional PUCCH resource identifier of a PUCCH resource from a PUCCH resource set.

Example 33 includes the method of example 31 or some other example herein, wherein the DL SPS configuration information includes an indication of a plurality of PUCCH resource identifiers corresponding to a respective plurality of PUCCH resources.

Example 34 includes the method of example 31 or some other example herein, wherein the indication of the substitute PUCCH resource includes an indication of a time offset for the substitute PUCCH resource.

Example 35 includes the method of example 28 or some other example herein, wherein the DL SPS configuration information includes an indication of a DL SPS occasion for which a physical downlink shared channel (PDSCH) can be provided with a DL SPS HARQ acknowledgement (ACK) without using a substitute PUCCH resource.

Example 36 includes the method of example 28 or some other example herein, wherein the DL SPS configuration information includes an indication of one or more uplink (UL) configured grant configurations with which to multiple a substitute PUCCH.

Example 37 includes the method of example 28 or some other example herein, wherein the DL SPS configuration information includes an indication of a PDSCH occasion associated with an index for HARQ feedback compression.

Example 38 includes the method of example 28 or some other example herein, wherein the DL SPS configuration information includes an indication of an alternate PUCCH resource for transmission of HARQ-ACK or uplink control information (UCI) based on a dynamic trigger.

Example 39 includes the method of example 38 or some other example herein, wherein the DL SPS configuration information includes an indication of enablement or disablement of a downlink control information (DCI) field that schedules the alternate PUCCH resource.

Example 40 includes the method of example 28 or some other example herein, wherein the DL SPS configuration information includes an indication of dynamic switching of a component carrier where dynamically triggered PUCCH may be transmitted.

Example 41 may include a method to enhance the HARQ-ID determination for URLLC Operating in Unlicensed Spectrum.

Example 42 may include the method of example 41 or some other example herein, wherein the legacy URLLC HARQ-ID determination is modified to account for multiple TB transmissions within a period.

Example 43 may include the method of examples 41-42 or some other example herein, wherein the formulas used to determine the HARQ-ID are modified such that within a period depending on the maximum number of TB allowed, a different HARQ-ID may be provided given a different TB index.

Example 44 may include the method of examples 41-42 or some other example herein, wherein the formulas used to determine the HARQ-ID are modified such that within a period depending on the maximum number of TB allowed, a different HARQ-ID may be provided, assuming that within a period and next one the time domain resources are equally distributed among TBs.

Example 45 may include the method of examples 41-42 or some other example herein, wherein the formulas used to determine the HARQ-ID are modified such that within a period depending on the resources allocated per TB (e.g., this is equivalent to PUSCH_Length×REPETITION_NUMBER, where PUSCH_Length is derived from the SLIV, and may corresponds to the length in terms of symbols of a TB transmission when a TB based transmission is configured, and REPETITION_NUMBER is as defined in 38.321 and is the total number of PUSCH transmissions of a TB), a different HARQ-ID may be provided.

Example 46 may include the method of examples 41-42 or some other example herein, wherein the formulas used to determine the HARQ-ID are modified such that within a period depending on the maximum number of TB allowed, and the resources allocated per TB (e.g., this is equivalent to PUSCH_Length×REPETITION_NUMBER, where PUSCH_Length is derived from the SLIV, and may corresponds to the length in terms of symbols of a TB transmission when a TB based transmission is configured, and REPETITION_NUMBER is as defined in 38.321 and is the total number of PUSCH transmissions of a TB), a different HARQ-ID may be provided.

Example 47 may include a method comprising: determining a HARQ ID for ultra-reliable and low latency communication (URLLC) on unlicensed spectrum according to one or more of the techniques described herein; and providing HARQ feedback for the URLLC based on the determined HARQ ID.

Example X1 may include one or more non-transitory, computer-readable media (NTCRM) that, when executed by one or more processors, cause a next generation Node B (gNB) to: determine downlink (DL) semi-persistent scheduling (SPS) configuration information that includes an indication of whether postponing hybrid automatic repeat request (HARQ) feedback is enabled or disabled; and encode a message for transmission to a user equipment (UE), the message including the DL SPS configuration information.

Example X2 may include the one or more NTCRM of Example X1, wherein the DL SPS configuration information includes an indication of a substitute physical uplink control channel (PUCCH) resource for the HARQ feedback.

Example X3 may include the one or more NTCRM of Example X2, wherein the indication of the substitute PUCCH resource includes: an indication of a PUCCH resource identifier of a PUCCH resource from a PUCCH resource set; an indication of a plurality of PUCCH resource identifiers corresponding to a respective plurality of PUCCH resources from which the UE is to select the substitute resource so that the substitute resource does not collide with a downlink symbol; or an indication of a time offset for the substitute PUCCH resource.

Example X4 may include the one or more NTCRM of Example X1, wherein the DL SPS configuration information includes an indication of a DL SPS occasion for which a physical downlink shared channel (PDSCH) is to be provided with a DL SPS HARQ acknowledgement (ACK) without using a substitute PUCCH resource.

Example X5 may include the one or more NRCRM of Example X1, wherein the DL SPS configuration information includes an indication of one or more uplink (UL) configured grant configurations with which to multiplex a substitute PUCCH.

Example X6 may include the one or more NTCRM of Example X1, wherein the DL SPS configuration information includes an indication of a PDSCH occasion associated with an index for HARQ feedback compression.

Example X7 may include the one or more NTCRM of Example X1, wherein the DL SPS configuration information includes an indication of an alternate PUCCH resource for transmission of the HARQ feedback based on a dynamic trigger.

Example X8 may include the one or more NTCRM of Example X7, wherein the DL SPS configuration information includes an indication of enablement or disablement of a downlink control information (DCI) field that schedules the alternate PUCCH resource.

Example X9 may include one or more non-transitory, computer-readable media (NTCRM) that, when executed by one or more processors, cause a user equipment (UE) to: receive downlink (DL) semi-persistent scheduling (SPS) configuration information that includes an indication of whether postponing hybrid automatic repeat request (HARQ) feedback is enabled or disabled; and encode HARQ feedback for transmission based on the DL SPS configuration information.

Example X10 may include the one or more NTCRM of Example X9, wherein the DL SPS configuration information includes an indication of a substitute physical uplink control channel (PUCCH) resource for the HARQ feedback.

Example X11 may include the one or more NTCRM of Example X10, wherein the indication of the substitute PUCCH resource includes: an indication of a PUCCH resource identifier of a PUCCH resource from a PUCCH resource set; an indication of a plurality of PUCCH resource identifiers corresponding to a respective plurality of PUCCH resources from which the UE is to select the substitute resource so that the substitute resource does not collide with a downlink symbol; or an indication of a time offset for the substitute PUCCH resource.

Example X12 may include the one or more NTCRM of Example X9, wherein the DL SPS configuration information includes an indication of a DL SPS occasion for which a physical downlink shared channel (PDSCH) is to be provided with a DL SPS HARQ acknowledgement (ACK) without using a substitute PUCCH resource.

Example X13 may include the one or more NRCRM of Example X9, wherein the DL SPS configuration information includes an indication of one or more uplink (UL) configured grant configurations with which to multiplex the HARQ feedback.

Example X14 may include the one or more NTCRM of Example X9, wherein the DL SPS configuration information includes an indication of a PDSCH occasion associated with an index for HARQ feedback compression.

Example X15 may include the one or more NTCRM of Example X9, wherein the DL SPS configuration information includes an indication of an alternate PUCCH resource for transmission of the HARQ feedback based on a dynamic trigger.

Example X16 may include the one or more NTCRM of Example X15, wherein the DL SPS configuration information includes an indication of enablement or disablement of a downlink control information (DCI) field that schedules the alternate PUCCH resource.

Example X17 may include one or more non-transitory, computer-readable media (NTCRM) that, when executed by one or more processors, cause a next generation Node B (gNB) to: provide a configured grant for an uplink transmission of a UE; and determine a hybrid automatic repeat request (HARQ) identifier (ID) for the uplink transmission based on a maximum number of transport blocks per period, wherein the maximum number is two or more.

Example X18 may include the one or more NTCRM of Example X17, wherein the uplink transmission is on unlicensed spectrum.

Example X19 may include the one or more NTCRM of Example X17, wherein no configured grant retransmission timer is configured for the configured uplink grant.

Example X20 may include the one or more NTCRM of Example X17, wherein the HARQ ID is determined with or without a harq-ProcID-Offset2 parameter configured.

Example Z01 may include an apparatus comprising means to perform one or more elements of a method described in or related to any of examples 1-47, X1-X20, or any other method or process described herein.

Example Z02 may include one or more non-transitory computer-readable media comprising instructions to cause an electronic device, upon execution of the instructions by one or more processors of the electronic device, to perform one or more elements of a method described in or related to any of examples 1-47, X1-X20, or any other method or process described herein.

Example Z03 may include an apparatus comprising logic, modules, or circuitry to perform one or more elements of a method described in or related to any of examples 1-47, X1-X20, or any other method or process described herein.

Example Z04 may include a method, technique, or process as described in or related to any of examples 1-47, X1-X20, or portions or parts thereof.

Example Z05 may include an apparatus comprising: one or more processors and one or more computer-readable media comprising instructions that, when executed by the one or more processors, cause the one or more processors to perform the method, techniques, or process as described in or related to any of examples 1-47, X1-X20, or portions thereof.

Example Z06 may include a signal as described in or related to any of examples 1-47, X1-X20, or portions or parts thereof.

Example Z07 may include a datagram, packet, frame, segment, protocol data unit (PDU), or message as described in or related to any of examples 1-47, X1-X20, or portions or parts thereof, or otherwise described in the present disclosure.

Example Z08 may include a signal encoded with data as described in or related to any of examples 1-47, X1-X20, or portions or parts thereof, or otherwise described in the present disclosure.

Example Z09 may include a signal encoded with a datagram, packet, frame, segment, protocol data unit (PDU), or message as described in or related to any of examples 1-47, X1-X20, or portions or parts thereof, or otherwise described in the present disclosure.

Example Z10 may include an electromagnetic signal carrying computer-readable instructions, wherein execution of the computer-readable instructions by one or more processors is to cause the one or more processors to perform the method, techniques, or process as described in or related to any of examples 1-47, X1-X20, or portions thereof.

Example Z11 may include a computer program comprising instructions, wherein execution of the program by a processing element is to cause the processing element to carry out the method, techniques, or process as described in or related to any of examples 1-47, X1-X20, or portions thereof.

Example Z12 may include a signal in a wireless network as shown and described herein.

Example Z13 may include a method of communicating in a wireless network as shown and described herein.

Example Z14 may include a system for providing wireless communication as shown and described herein.

Example Z15 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

### Abbreviations

Unless used differently herein, terms, definitions, and abbreviations may be consistent with terms, definitions, and abbreviations defined in 3GPP TR 21.905 v16.0.0 (2019-06). For the purposes of the present document, the following abbreviations may apply to the examples and embodiments discussed herein.

| | |
|---|---|
| 3GPP | Third Generation Partnership Project |
| 4G | Fourth Generation |
| 5G | Fifth Generation |
| 5GC | 5G Core network |
| ACK | Acknowledgement |
| AF | Application Function |
| AM | Acknowledged Mode |
| AMBR | Aggregate Maximum Bit Rate |
| AMF | Access and Mobility Management Function |
| AN | Access Network |
| ANR | Automatic Neighbour Relation |
| AP | Application Protocol, Antenna Port, Access Point |
| API | Application Programming Interface |
| APN | Access Point Name |
| ARP | Allocation and Retention Priority |
| ARQ | Automatic Repeat Request |
| AS | Access Stratum |
| ASN.1 | Abstract Syntax Notation One |
| AUSF | Authentication Server Function |
| AWGN | Additive White Gaussian Noise |
| BAP | Backhaul Adaptation Protocol |
| BCH | Broadcast Channel |
| BER | Bit Error Ratio |
| BFD | Beam Failure Detection |
| BLER | Block Error Rate |
| BPSK | Binary Phase Shift Keying |
| BRAS | Broadband Remote Access Server |
| BSS | Business Support System |
| BS | Base Station |
| BSR | Buffer Status Report |
| BW | Bandwidth |
| BWP | Bandwidth Part |
| C-RNTI | Cell Radio Network Temporary Identity |
| CA | Carrier Aggregation, Certification Authority |
| CAPEX | CAPital EXpenditure |
| CBRA | Contention Based Random Access |
| CC | Component Carrier, |
| | Country Code, |
| | Cryptographic Checksum |
| CCA | Clear Channel Assessment |
| CCE | Control Channel Element |
| CCCH | Common Control Channel |
| CE | Coverage Enhancement |
| CDM | Content Delivery Network |
| CDMA | Code-Division Multiple Access |
| CFRA | Contention Free Random Access |
| CG | Cell Group |
| CI | Cell Identity |
| CID | Cell-ID (e.g., |
| | positioning method) |
| CIM | Common Information Model |
| CIR | Carrier to Interference Ratio |
| CK | Cipher Key |
| CM | Connection Management, |
| | Conditional Mandatory |
| CMAS | Commercial Mobile Alert Service |
| CMD | Command |
| CMS | Cloud Management System |
| CO | Conditional Optional |
| CoMP | Coordinated Multi-Point |
| CORESET | Control Resource Set |
| COTS | Commercial Off-The-Shelf |
| CP | Control Plane, |
| | Cyclic Prefix, |
| | Connection Point |
| CPD | Connection Point Descriptor |
| CPE | Customer Premise Equipment |
| CPICH | Common Pilot Channel |
| CQI | Channel Quality Indicator |
| CPU | CSI processing unit, Central Processing Unit |
| C/R | Command/Response field bit |
| CRAN | Cloud Radio Access Network, Cloud RAN |
| CRB | Common Resource Block |
| CRC | Cyclic Redundancy Check |
| CRI | Channel-State Information Resource Indicator, |
| | CSI-RS Resource Indicator |
| C-RNTI | Cell RNTI |
| CS | Circuit Switched |
| CSAR | Cloud Service Archive |
| CSI | Channel-State Information |
| CSI-IM | CSI Interference Measurement |
| CSI-RS | CSI Reference Signal |
| CSI-RSRP | CSI reference signal received power |
| CSI-RSRQ | CSI reference signal received quality |
| CSI-SINR | CSI signal-to-noise and interference ratio |
| CSMA | Carrier Sense Multiple Access |
| CSMA/CA | CSMA with collision avoidance |
| CSS | Common Search Space, Cell-specific Search Space |
| CTS | Clear-to-Send |
| CW | Codeword |
| CWS | Contention Window Size |
| D2D | Device-to-Device |
| DC | Dual Connectivity, Direct Current |
| DCI | Downlink Control Information |
| DF | Deployment Flavour |
| DL | Downlink |
| DMTF | Distributed Management Task Force |
| DPDK | Data Plane Development Kit |
| DM-RS | DMRS Demodulation Reference Signal |
| DN | Data Network |
| DRB | Data Radio Bearer |
| DRS | Discovery Reference Signal |
| DRX | Discontinuous Reception |
| DSL | Domain Specific Language. Digital Subscriber Line |
| DSLAM | DSL Access Multiplexer |
| DwPTS | Downlink Pilot Time Slot |
| E-LAN | Ethernet Local Area Network |
| E2E | End-to-End |
| ECCA | extended clear channel assessment, extended CCA |
| ECCE | Enhanced Control Channel Element, Enhanced CCE |
| ED | Energy Detection |
| EDGE | Enhanced Datarates for GSM Evolution (GSM Evolution) |
| EGMF | Exposure Governance Management Function |
| EGPRS | Enhanced GPRS |
| EIR | Equipment Identity Register |
| eLAA | enhanced Licensed Assisted Access, enhanced LAA |
| EM | Element Manager |
| eMBB | Enhanced Mobile Broadband |
| EMS | Element Management System |
| eNB | evolved NodeB, |
| E-UTRAN | Node B |
| EN-DC | E-UTRA-NR Dual Connectivity |
| EPC | Evolved Packet Core |
| EPDCCH | enhanced PDCCH, enhanced Physical Downlink |
| | Control Cannel |
| EPRE | Energy per resource element |
| EPS | Evolved Packet System |
| EREG | enhanced REG, enhanced resource element groups |
| ETSI | European Telecommunications Standards Institute |
| ETWS | Earthquake and Tsunami Warning System |
| eUICC | embedded UICC, embedded Universal Integrated |
| | Circuit Card |
| E-UTRA | Evolved UTRA |
| E-UTRAN | Evolved UTRAN |
| EV2X | Enhanced V2X |
| F1AP | F1 Application Protocol |
| F1-C | F1 Control plane interface |
| F1-U | F1 User plane interface |
| FACCH | Fast Associated Control CHannel |
| FACCH/F | Fast Associated Control Channel/Full rate |
| FACCH/H | Fast Associated Control Channel/Half rate |
| FACH | Forward Access Channel |
| FAUSCH | Fast Uplink Signalling Channel |
| FB | Functional Block |
| FBI | Feedback Information |
| FCC | Federal Communications Commission |
| FCCH | Frequency Correction CHannel |
| FDD | Frequency Division Duplex |
| FDM | Frequency Division Multiplex |
| FDMA | Frequency Division Multiple Access |
| FE | Front End |
| FEC | Forward Error Correction |
| FFS | For Further Study |
| FFT | Fast Fourier Transformation |
| feLAA | further enhanced Licensed Assisted Acces, |
| | further enhanced LAA |
| FN | Frame Number |
| FPGA | Field-Programmable Gate Array |
| FR | Frequency Range |
| G-RNTI | GERAN Radio Network Temporary Identity |
| GERAN | GSM EDGE RAN, GSM EDGE Radio Access Network |
| GGSN | Gateway GPRS Support Node |
| GLONASS | GLObal'naya NAvigatsionnaya Sputnikovaya Sistema |
| | (Engl.: Global Navigation Satellite System) |
| gNB | Next Generation NodeB |
| gNB-CU | gNB-centralized unit, Next Generation NodeB centralized unit |
| gNB-DU | gNB-distributed unit, Next Generation NodeB distributed unit |
| GNSS | Global Navigation Satellite System |
| GPRS | General Packet Radio Service |
| GSM | Global System for Mobile Communications, |
| | Groupe Spécial Mobile |
| GTP | GPRS Tunneling Protocol |
| GTP-UGPRS | Tunnelling Protocol for User Plane |
| GTS | Go To Sleep Signal (related to WUS) |
| GUMMEI | Globally Unique MME Identifier |
| GUTI | Globally Unique Temporary UE Identity |
| HARQ | Hybrid ARQ, Hybrid Automatic Repeat Request |
| HANDO | Handover |
| HFN | HyperFrame Number |
| HHO | Hard Handover |
| HLR | Home Location Register |
| HN | Home Network |
| HO | Handover |
| HPLMN | Home Public Land Mobile Network |
| HSDPA | High Speed Downlink Packet Access |
| HSN | Hopping Sequence Number |
| HSPA | High Speed Packet Access |
| HSS | Home Subscriber Server |
| HSUPA | High Speed Uplink Packet Access |
| HTTP | Hyper Text Transfer Protocol |
| HTTPS | Hyper Text Transfer Protocol Secure |
| | (https is http/1.1 over SSL, i.e. port 443) |
| I-Block | Information Block |
| ICCID | Integrated Circuit Card Identification |
| IAB | Integrated Access and Backhaul |
| ICIC | Inter-Cell Interference Coordination |
| ID | Identity, identifier |
| IDFT | Inverse Discrete Fourier Transform |
| IE | Information element |
| IBE | In-Band Emission |
| IEEE | Institute of Electrical and Electronics Engineers |
| IEI | Information Element Identifier |
| IEIDL | Information Element Identifier Data Length |
| IETF | Internet Engineering Task Force |
| IF | Infrastructure |
| IM | Interference Measurement, Intermodulation, IP Multimedia |
| IMC | IMS Credentials |
| IMEI | International Mobile Equipment Identity |
| IMGI | International mobile group identity |
| IMPI | IP Multimedia Private Identity |
| IMPU | IP Multimedia PUblic identity |
| IMS | IP Multimedia Subsystem |
| IMSI | International Mobile Subscriber Identity |
| IoT | Internet of Things |
| IP | Internet Protocol |
| Ipsec | IP Security, Internet Protocol Security |
| IP-CAN | IP-Connectivity Access Network |
| IP-M | IP Multicast |
| IPv4 | Internet Protocol Version 4 |
| IPv6 | Internet Protocol Version 6 |
| IR | Infrared |
| IS | In Sync |
| IRP | Integration Reference Point |
| ISDN | Integrated Services Digital Network |
| ISIM | IM Services Identity Module |
| ISO | International Organisation for Standardisation |
| ISP | Internet Service Provider |
| IWF | Interworking-Function |
| I-WLAN | Interworking WLAN Constraint length of the convolutional |
| | code, USIM Individual key |
| kB | Kilobyte (1000 bytes) |
| kbps | kilo-bits per second |
| Kc | Ciphering key |
| Ki | Individual subscriber authentication key |
| KPI | Key Performance Indicator |
| KQI | Key Quality Indicator |
| KSI | Key Set Identifier |
| ksps | kilo-symbols per second |
| KVM | Kernel Virtual Machine |
| L1 | Layer 1 (physical layer) |
| L1-RSRP | Layer 1 reference signal |
| L2 | Layer 2 (data link layer) |
| L3 | Layer 3 (network layer) |
| LAA | Licensed Assisted Access |
| LAN | Local Area Network |
| LBT | Listen Before Talk |
| LCM | LifeCycle Management |
| LCR | Low Chip Rate |
| LCS | Location Services |
| LCID | Logical Channel ID |
| LI | Layer Indicator |
| LLC | Logical Link Control, Low Layer Compatibility |
| LPLMN | Local PLMN |
| LPP | LTE Positioning Protocol |
| LSB | Least Significant Bit |
| LTE | Long Term Evolution |
| LWA | LTE-WLAN aggregation |
| LWIP | LTE/WLAN Radio Level Integration with IPsec Tunnel |
| LTE | Long Term Evolution |
| M2M | Machine-to-Machine |
| MAC | Medium Access Control (protocol layering context) |
| MAC | Message authentication code (security/encryption context) |
| MAC-A | MAC used for authentication and key agreement |
| | (TSG T WG3 context) |
| MAC-IMAC | used for data integrity of signalling messages |
| | (TSG T WG3 context) |
| MANO | Management and Orchestration |
| MBMS | Multimedia Broadcast and Multicast Service |
| MBSFN | Multimedia Broadcast multicast service Single |
| | Frequency Network |
| MCC | Mobile Country Code |
| MCG | Master Cell Group |
| MCOT | Maximum Channel Occupancy Time |
| MCS | Modulation and coding scheme |
| MDAF | Management Data Analytics Function |
| MDAS | Management Data Analytics Service |
| MDT | Minimization of Drive Tests |
| ME | Mobile Equipment |
| MeNB | master eNB |
| MER | Message Error Ratio |
| MGL | Measurement Gap Length |
| MGRP | Measurement Gap Repetition Period |
| MIB | Master Information Block, Management Information Base |
| MIMO | Multiple Input Multiple Output |
| MLC | Mobile Location Centre |
| MM | Mobility Management |
| MME | Mobility Management Entity |
| MN | Master Node |
| MnS | Management Service |
| MO | Measuremenet Object, Mobile Originated |
| MPBCH | MTC Physical Broadcast CHannel |
| MPDCCH | MTC Physical Downlink Control CHannel |
| MPDSCH | MTC Physical Downlink Shared CHannel |
| MPRACH | MTC Physical Random Access CHannel |
| MPUSCH | MTC Physical Uplink Shared Channel |
| MPLS | MultiProtocol Label Switching |
| MS | Mobile Station |
| MSB | Most Significant Bit |
| MSC | Mobile Switching Centre |
| MSI | Minimum System Information, MCH Scheduling Information |
| MSID | Mobile Station Identifier |
| MSIN | Mobile Station Identification Number |
| MSISDN | Mobile Subscriber ISDN Number |
| MT | Mobile Terminated, Mobile Termination |
| MTC | Machine-Type Communications |
| mMTC | massive MTC, massive Machine-Type Communications |
| MU-MIMO | Multi User MIMO |
| MWUS | MTC wake-up signal, MTC WUS |
| NACK | Negative Acknowledgement |
| NAI | Network Access Identifier |
| NAS | Non-Access Stratum, Non-Access Stratum layer |
| NCT | Network Connectivity Topology |
| NC-JT | Non-Coherent Joint Transmission |
| NEC | Network Capability Exposure |
| NE-DC | NR-E-UTRA Dual Connectivity |
| NEF | Network Exposure Function |
| NF | Network Function |
| NFP | Network Forwarding Path |
| NFPD | Network Forwarding Path Descriptor |
| NFV | Network Functions Virtualization |
| NFVI | NFV Infrastructure |
| NFVO | NFV Orchestrator |
| NG | Next Generation, Next Gen |
| NGEN-DC | NG-RAN E-UTRA-NR Dual Connectivity |
| NM | Network Manager |
| NMS | Network Management System |
| N-PoP | Network Point of Presence |
| NMIB, | N-MIB Narrowband MIB |
| NPBCH | Narrowband Physical Broadcast CHannel |
| NPDCCH | Narrowband Physical Downlink Control CHannel |
| NPDSCH | Narrowband Physical Downlink Shared CHannel |
| NPRACH | Narrowband Physical Random Access CHannel |
| NPUSCH | Narrowband Physical Uplink Shared CHannel |
| NPSS | Narrowband Primary Synchronization Signal |
| NSSS | Narrowband Secondary Synchronization Signal |
| NR | New Radio, Neighbour Relation |
| NRF | NF Repository Function |
| NRS | Narrowband Reference Signal |
| NS | Network Service |
| NSA | Non-Standalone operation mode |
| NSD | Network Service Descriptor |
| NSR | Network Service Record |
| NSSAI | Network Slice Selection Assistance Information |
| S-NNSAI | Single-NSSAI |
| NSSF | Network Slice Selection Function |
| NW | Network |
| NWUS | Narrowband wake-up signal, Narrowband WUS |
| NZP | Non-Zero Power |
| O&M | Operation and Maintenance |
| ODU2 | Optical channel Data Unit-type 2 |
| OFDM | Orthogonal Frequency Division Multiplexing |
| OFDMA | Orthogonal Frequency Division Multiple Access |
| OOB | Out-of-band |
| OOS | Out of Sync |
| OPEX | OPerating EXpense |
| OSI | Other System Information |
| OSS | Operations Support System |
| OTA | over-the-air |
| PAPR | Peak-to-Average Power Ratio |
| PAR | Peak to Average Ratio |
| PBCH | Physical Broadcast Channel |
| PC | Power Control, Personal Computer |
| PCC | Primary Component Carrier, Primary CC |
| PCell | Primary Cell |
| PCI | Physical Cell ID, Physical Cell Identity |
| PCEF | Policy and Charging Enforcement Function |
| PCF | Policy Control Function |
| PCRF | Policy Control and Charging Rules Function |
| PDCP | Packet Data Convergence Protocol, Packet Data |
| | Convergence Protocol layer |
| PDCCH | Physical Downlink Control Channel |
| PDCP | Packet Data Convergence Protocol |
| PDN | Packet Data Network, Public Data Network |
| PDSCH | Physical Downlink Shared Channel |
| PDU | Protocol Data Unit |
| PEI | Permanent Equipment Identifiers |
| PFD | Packet Flow Description |
| P-GW | PDN Gateway |
| PHICH | Physical hybrid-ARQ indicator channel |
| PHY | Physical layer |
| PLMN | Public Land Mobile Network |
| PIN | Personal Identification Number |
| PM | Performance Measurement |
| PMI | Precoding Matrix Indicator |
| PNF | Physical Network Function |
| PNFD | Physical Network Function Descriptor |
| PNFR | Physical Network Function Record |
| POC | PTT over Cellular PP, |
| PTP | Point-to-Point |
| PPP | Point-to-Point Protocol |
| PRACH | Physical RACH |
| PRB | Physical resource block |
| PRG | Physical resource block group |
| ProSe | Proximity Services, Proximity-Based Service |
| PRS | Positioning Reference Signal |
| PRR | Packet Reception Radio |
| PS | Packet Services |
| PSBCH | Physical Sidelink Broadcast Channel |
| PSDCH | Physical Sidelink Downlink Channel |
| PSCCH | Physical Sidelink Control Channel |
| PSFCH | Physical Sidelink Feedback Channel |
| PSSCH | Phsyical Sidelink Shared Channel |
| PSCell | Primary SCell |
| PSS | Primary Synchronization Signal |
| PSTN | Public Switched Telephone Network |
| PT-RS | Phase-tracking reference signal |
| PTT | Push-to-Talk |
| PUCCH | Physical Uplink Control Channel |
| PUSCH | Physical Uplink Shared Channel |
| QAM | Quadrature Amplitude Modulation |
| QCI | QoS class of identifier |
| QCL | Quasi co-location |
| QFI | QoS Flow ID, QoS Flow Identifier |
| QoS | Quality of Service QPSK Quadrature |
| QPSK | Quadrature (Quaternary) Phase Shift Keying |
| QZSS | Quasi-Zenith Satellite System |
| RA-RNTI | Random Access RNTI |
| RAB | Radio Access Bearer, Random Access Burst |
| RACH | Random Access Channel |
| RADIUS | Remote Authentication Dial In User Service |
| RAN | Radio Access Network |
| RAND | RANDom number (used for authentication) |
| RAR | Random Access Response |
| RAT | Radio Access Technology |
| RAU | Routing Area Update |
| RB | Resource block, Radio Bearer |
| RBG | Resource block group |
| REG | Resource Element Group |
| Rel | Release |
| REQ | REQuest |
| RF | Radio Frequency |
| RI | Rank Indicator |
| RIV | Resource indicator value |
| RL | Radio Link |
| RLC | Radio Link Control, Radio Link Control layer |
| RLC AM | RLC Acknowledged Mode |
| RLC UM | RLC Unacknowledged Mode |
| RLF | Radio Link Failure |
| RLM | Radio Link Monitoring |
| RLM-RS | Reference Signal for RLM |
| RM | Registration Management |
| RMC | Reference Measurement Channel |
| RMSI | Remaining MSI, Remaining Minimum System Information |
| RN | Relay Node |
| RNC | Radio Network Controller |
| RNL | Radio Network Layer |
| RNTI | Radio Network Temporary Identifier |
| ROHC | RObust Header Compression |
| RRC | Radio Resource Control, Radio Resource Control layer |
| RRM | Radio Resource Management |
| RS | Reference Signal |
| RSRP | Reference Signal Received Power |
| RSRQ | Reference Signal Received Quality |
| RSSI | Received Signal Strength Indicator |
| RSU | Road Side Unit |
| RSTD | Reference Signal Time difference |
| RTP | Real Time Protocol |
| RTS | Ready-To-Send |
| RTT | Rount Trip Time |
| Rx | Reception, Receiving, Receiver |
| S1AP | S1 Application Protocol |
| S1-MME | S1 for the control plane |
| S1-U | S1 for the user plane |
| S-GW | Serving Gateway |
| S-RNTI | SRNC Radio Network Temporary Identity |
| S-TMSI | SAE Temporary Mobile Station Identifier |
| SA | Standalone operation mode |
| SAE | System Architecture Evolution |
| SAP | Service Access Point |
| SAPD | Service Access Point Descriptor |
| SAPI | Service Access Point Identifier |
| SCC | Secondary Component Carrier, Secondary CC |
| SCell | Secondary Cell |
| SC-FDMA | Single Carrier Frequency Division Multiple Access |
| SCG | Secondary Cell Group |
| SCM | Security Context Management |
| SCS | Subcarrier Spacing |
| SCTP | Stream Control Transmission Protocol |
| SDAP | Service Data Adaptation Protocol, Service Data Adaptation |
| | Protocol layer |
| SDL | Supplementary Downlink |
| SDNF | Structured Data Storage Network Function |
| SDP | Session Description Protocol |
| SDSF | Structured Data Storage Function |
| SDU | Service Data Unit |
| SEAF | Security Anchor Function |
| SeNB | secondary eNB |
| SEPP | Security Edge Protection Proxy |
| SFI | Slot format indication |
| SFTD | Space-Frequency Time Diversity, SFN and frame |
| | timing difference |
| SFN | System Frame Number or Single Frequency Network |
| SgNB | Secondary gNB |
| SGSN | Serving GPRS Support Node |
| S-GW | Serving Gateway |
| SI | System Information |
| SI-RNTI | System Information RNTI |
| SIB | System Information Block |
| SIM | Subscriber Identity Module |
| SIP | Session Initiated Protocol |
| SiP | System in Package |
| SL | Sidelink |
| SLA | Service Level Agreement |
| SM | Session Management |
| SMF | Session Management Function |
| SMS | Short Message Service |
| SMSF | SMS Function |
| SMTC | SSB-based Measurement Timing Configuration |
| SN | Secondary Node, Sequence Number |
| SoC | System on Chip |
| SON | Self-Organizing Network |
| SpCell | Special Cell |
| SP-CSI-RNTI | Semi-Persistent CSI RNTI |
| SPS | Semi-Persistent Scheduling |
| SQN | Sequence number |
| SR | Scheduling Request |
| SRB | Signalling Radio Bearer |
| SRS | Sounding Reference Signal |
| SS | Synchronization Signal |
| SSB | SS Block |
| SSBRI | SSB Resource Indicator |
| SSC | Session and Service Continuity |
| SS-RSRP | Synchronization Signal based Reference Signal |
| | Received Power |
| SS-RSRQ | Synchronization Signal based Reference Signal |
| | Received Quality |
| SS-SINR | Synchronization Signal based Signal to Noise and |
| | Interference Ratio |
| SSS | Secondary Synchronization Signal |
| SSSG | Search Space Set Group |
| SSIF | Search Space Set Indicator |
| SST | Slice/Service Types |
| SU-MIMO | Single User MIMO |
| SUL | Supplementary Uplink |
| TA | Timing Advance, Tracking Area |
| TAC | Tracking Area Code |
| TAG | Timing Advance Group |
| TAU | Tracking Area Update |
| TB | Transport Block |
| TBS | Transport Block Size |
| TBD | To Be Defined |
| TCI | Transmission Configuration Indicator |
| TCP | Transmission Communication Protocol |
| TDD | Time Division Duplex |
| TDM | Time Division Multiplexing |
| TDMA | Time Division Multiple Access |
| TE | Terminal Equipment |
| TEID | Tunnel End Point Identifier |
| TFT | Traffic Flow Template |
| TMSI | Temporary Mobile Subscriber Identity |
| TNL | Transport Network Layer |
| TPC | Transmit Power Control |
| TPMI | Transmitted Precoding Matrix Indicator |
| TR | Technical Report |
| TRP, TRxP | Transmission Reception Point |
| TRS | Tracking Reference Signal |
| TRx | Transceiver |
| TS | Technical Specifications, Technical Standard |
| TTI | Transmission Time Interval |
| Tx | Transmission, Transmitting, Transmitter |
| U-RNTI | UTRAN Radio Network Temporary Identity |
| UART | Universal Asynchronous Receiver and Transmitter |
| UCI | Uplink Control Information |
| UE | User Equipment |
| UDM | Unified Data Management |
| UDP | User Datagram Protocol |
| UDR | Unified Data Repository |
| UDSF | Unstructured Data Storage Network Function |
| UICC | Universal Integrated Circuit Card |
| UL | Uplink |
| UM | Unacknowledged Mode |
| UML | Unified Modelling Language |
| UMTS | Universal Mobile Telecommunications System |
| UP | User Plane |
| UPF | User Plane Function |
| URI | Uniform Resource Identifier |
| URL | Uniform Resource Locator |
| URLLC | Ultra-Reliable and Low Latency |
| USB | Universal Serial Bus |
| USIM | Universal Subscriber Identity Module |
| USS | UE-specific search space |
| UTRA | UMTS Terrestrial Radio Access |
| UTRAN | Universal Terrestrial Radio Access Network |
| UwPTS | Uplink Pilot Time Slot |
| V2I | Vehicle-to-Infrastruction |
| V2P | Vehicle-to-Pedestrian |
| V2V | Vehicle-to-Vehicle |
| V2X | Vehicle-to-everything |
| VIM | Virtualized Infrastructure Manager |
| VL | Virtual Link, |
| VLAN | Virtual LAN, Virtual Local Area Network |
| VM | Virtual Machine |
| VNF | Virtualized Network Function |
| VNFFG | VNF Forwarding Graph |
| VNFFGD | VNF Forwarding Graph Descriptor |
| VNFM | VNF Manager |
| VoIP | Voice-over-IP, Voice-over-Internet Protocol |
| VPLMN | Visited Public Land Mobile Network |
| VPN | Virtual Private Network |
| VRB | Virtual Resource Block |
| WiMAX | Worldwide Interoperability for Microwave Access |
| WLAN | Wireless Local Area Network |
| WMAN | Wireless Metropolitan Area Network |
| WPAN | Wireless Personal Area Network |
| X2-C | X2-Control plane |
| X2-U | X2-User plane |
| XML | eXtensible Markup Language |
| XRES | EXpected user RESponse |
| XOR | eXclusive OR |
| ZC | Zadoff-Chu |
| ZP | Zero Power |

### Terminology

For the purposes of the present document, the following terms and definitions are applicable to the examples and embodiments discussed herein.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. Processing circuitry may include one or more processing cores to execute instructions and one or more memory structures to store program and data information. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. Processing circuitry may include more hardware accelerators, which may be microprocessors, programmable processing devices, or the like. The one or more hardware accelerators may include, for example, computer vision (CV) and/or deep learning (DL) accelerators. The terms “application circuitry” and/or “baseband circuitry” may be considered synonymous to, and may be referred to as, “processor circuitry.”

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

The term “information element” refers to a structural element containing one or more fields. The term “field” refers to individual contents of an information element, or a data element that contains content.

The term “SMTC” refers to an SSB-based measurement timing configuration configured by SSB-MeasurementTimingConfiguration.

The term “SSB” refers to an SS/PBCH block.

The term “a Primary SGCell” refers to the MCG cell, operating on the primary frequency, in which the UE either performs the initial connection establishment procedure or initiates the connection re-establishment procedure.

The term “Primary SCG Cell” refers to the SCG cell in which the UE performs random access when performing the Reconfiguration with Sync procedure for DC operation.

The term “Secondary Cell” refers to a cell providing additional radio resources on top of a Special Cell for a UE configured with CA.

The term “Secondary Cell Group” refers to the subset of serving cells comprising the PSCell and zero or more secondary cells for a UE configured with DC.

The term “Serving Cell” refers to the primary cell for a UE in RRC_CONNECTED not configured with CA/DC there is only one serving cell comprising of the primary cell.

The term “serving cell” or “serving cells” refers to the set of cells comprising the Special Cell(s) and all secondary cells for a UE in RRC_CONNECTED configured with CA/.

The term “Special Cell” refers to the PCell of the MCG or the PSCell of the SCG for DC operation; otherwise, the term “Special Cell” refers to the Pcell.

1. One or more non-transitory, computer-readable media (NTCRM) that, when executed by one or more processors, cause a next generation Node B (gNB) to:
determine downlink (DL) semi-persistent scheduling (SPS) configuration information that includes an indication of whether postponing hybrid automatic repeat request (HARQ) feedback is enabled or disabled; and
encode a message for transmission to a user equipment (UE), the message including the DL SPS configuration information.

2. The one or more NTCRM of claim 1, wherein the DL SPS configuration information includes an indication of a substitute physical uplink control channel (PUCCH) resource for the HARQ feedback.

3. The one or more NTCRM of claim 2, wherein the indication of the substitute PUCCH resource includes:
an indication of a PUCCH resource identifier of a PUCCH resource from a PUCCH resource set;
an indication of a plurality of PUCCH resource identifiers corresponding to a respective plurality of PUCCH resources from which the UE is to select the substitute resource so that the substitute resource does not collide with a downlink symbol; or
an indication of a time offset for the substitute PUCCH resource.

4. The one or more NTCRM of claim 1, wherein the DL SPS configuration information includes an indication of a DL SPS occasion for which a physical downlink shared channel (PDSCH) is to be provided with a DL SPS HARQ acknowledgement (ACK) without using a substitute PUCCH resource.

5. The one or more NRCRM of claim 1, wherein the DL SPS configuration information includes an indication of one or more uplink (UL) configured grant configurations with which to multiplex a substitute PUCCH.

6. The one or more NTCRM of claim 1, wherein the DL SPS configuration information includes an indication of a PDSCH occasion associated with an index for HARQ feedback compression.

7. The one or more NTCRM of claim 1, wherein the DL SPS configuration information includes an indication of an alternate PUCCH resource for transmission of the HARQ feedback based on a dynamic trigger.

8. The one or more NTCRM of claim 7, wherein the DL SPS configuration information includes an indication of enablement or disablement of a downlink control information (DCI) field that schedules the alternate PUCCH resource.

9. One or more non-transitory, computer-readable media (NTCRM) that, when executed by one or more processors, cause a user equipment (UE) to:
receive downlink (DL) semi-persistent scheduling (SPS) configuration information that includes an indication of whether postponing hybrid automatic repeat request (HARQ) feedback is enabled or disabled; and
encode HARQ feedback for transmission based on the DL SPS configuration information.

10. The one or more NTCRM of claim 9, wherein the DL SPS configuration information includes an indication of a substitute physical uplink control channel (PUCCH) resource for the HARQ feedback.

11. The one or more NTCRM of claim 10, wherein the indication of the substitute PUCCH resource includes:
an indication of a PUCCH resource identifier of a PUCCH resource from a PUCCH resource set;
an indication of a plurality of PUCCH resource identifiers corresponding to a respective plurality of PUCCH resources from which the UE is to select the substitute resource so that the substitute resource does not collide with a downlink symbol; or
an indication of a time offset for the substitute PUCCH resource.

12. The one or more NTCRM of claim 9, wherein the DL SPS configuration information includes an indication of a DL SPS occasion for which a physical downlink shared channel (PDSCH) is to be provided with a DL SPS HARQ acknowledgement (ACK) without using a substitute PUCCH resource.

13. The one or more NRCRM of claim 9, wherein the DL SPS configuration information includes an indication of one or more uplink (UL) configured grant configurations with which to multiplex the HARQ feedback.

14. The one or more NTCRM of claim 9, wherein the DL SPS configuration information includes an indication of a PDSCH occasion associated with an index for HARQ feedback compression.

15. The one or more NTCRM of claim 9, wherein the DL SPS configuration information includes an indication of an alternate PUCCH resource for transmission of the HARQ feedback based on a dynamic trigger.

16. The one or more NTCRM of claim 15, wherein the DL SPS configuration information includes an indication of enablement or disablement of a downlink control information (DCI) field that schedules the alternate PUCCH resource.

17. One or more non-transitory, computer-readable media (NTCRM) that, when executed by one or more processors, cause a next generation Node B (gNB) to:
provide a configured grant for an uplink transmission of a UE;
determine a hybrid automatic repeat request (HARQ) identifier (ID) for the uplink transmission based on a maximum number of transport blocks per period, wherein the maximum number is two or more.

18. The one or more NTCRM of claim 17, wherein the uplink transmission is on unlicensed spectrum.

19. The one or more NTCRM of claim 17, wherein no configured grant retransmission timer is configured for the configured uplink grant.

20. The one or more NTCRM of claim 17, wherein the HARQ ID is determined with or without a harq-ProcID-Offset2 parameter configured.
